(19) United States
(12) Patent Application Publication
(10) Pub. No.: US 2005/0216139 A1
(43) Pub. Date: Sep. 29, 2005

(54) Method and apparatus for facilitating information, security and transaction exchange in aviation

(76) Inventors: John J. Laughlin, Houston, TX (US); John F. Mewshaw, Roswell, GA (US); Michael T. Mewshaw, Tallahassee, FL (US); Damon V. Janis, Katy, TX (US); Andrew B. Hodgson, Houston, TX (US)

Correspondence Address: Hugh R. Kress, Suite 1800, 5718 Westheimer, Houston, TX, 77057, US

(21) Appl. No.: 10/943,722

(22) Filed: Sep. 17, 2004

Related U.S. Application Data
(60) Provisional application No. 60/504,710, filed on Sep. 18, 2003.
(60) Provisional application No. 60/538,811, filed on Jan. 23, 2004.
(60) Provisional application No. 60/559,116, filed on Apr. 2, 2004.

(51) Int. Cl. B64C 1/00

(52) U.S. Cl. 701/3

(57) ABSTRACT

A method and apparatus for creating a computerized market and integrated service chain for the aviation industry by use of a plurality of participant terminals using software tools and electronic devices. The present invention provides suppliers with specialized marketing and pricing tools for participating and non-participating aircraft operators and offers aircraft operators tools for displaying, managing, and analyzing suppliers' pricing and service offerings. The invention additionally creates a means for aircraft operators to integrate scheduling activities with the purchase of fuel and services in a paperless, detailed reporting environment, while using one or more credit providers but without the need for pilots to present any physical form of payment. In a preferred embodiment of the invention, suppliers are provided a method to display, manage, and integrate service requests from all aircraft operators. The present invention also creates a more secure operating environment for aircraft, crew members, passengers, airports, and the nation's infrastructure through a crew/passenger ramp access verification process and by transmitting to the aircraft operator, departure facility, TSA, FAA, NORAD, and other appropriate government agencies, risk scoring algorithms that quantify the potential risk posed by each aircraft.

### RELATED APPLICATION DATA

This application claims the priority of prior U.S. provisional application Ser. No. 60/504,710 filed on Sep. 18, 2003. This application further claims the priority of prior U.S. provisional application Ser. No. 60/538,811 filed on Jan. 23, 2004. This application further claims the priority of prior provisional application Ser. No. 60/559,116 filed on Apr. 2, 2004. All of these provisional applications are hereby incorporated by reference herein in their respective entireties.

### FIELD OF THE INVENTION

The present invention is generally directed to facilitating an information, security, and transaction exchanges in the general aviation industry. More specifically, the present invention provides a system and method of transacting business and exchanging and displaying information between general aviation participants such as aircraft owner/operators, pilots, departure facilities, fuel suppliers, credit providers, third-party suppliers, the Transportation Security Administration (TSA), NORAD, and the Federal Aviation Administration (FAA).

### BACKGROUND OF THE INVENTION

With the exception of most commercial airline and military operations, aircraft are serviced by facilities known as Fixed Base Operators (FBOs). These suppliers offer fuel and miscellaneous ground services such as maintenance, service, and rental cars.

Today, FBOs have no method to efficiently market services, or to gather information necessary to respond to price and service requests from aircraft operators. At present, aircraft operators (ACOPs) for the most part transact business using labor-intensive processes such as placing phone calls to FBOs to inquire about the price of fuel and availability of services. Handling customer price change notifications remains a cumbersome, time consuming task.

The absence of trading automation perpetuates significant market inefficiencies within the general aviation industry. Market logistics render the cost of marketing prohibitive for most FBOs. Lacking a viable alternative, FBOs often surrender a significant percentage of their margins to middlemen in return for sourcing customers.

FBO customer service personnel manually record aircraft arrival, departure, and service requests. They have no means to electronically link aircraft, crew, passenger preferences and service requests to an integrated display of incoming and outgoing aircraft. They also lack an effective means by which the dynamic status of service requirements can be displayed and monitored. (As used herein, the term “dynamic” is intended to mean that certain flight parameters, such as flight departure and arrival, service request fulfillment, and so on, will change throughout the course of a flight.)

Typically, FBOs maintain a multitude of pricing structures such as formula, manual, cost plus, and discount to retail posting. In addition to general quotations, prices are tailored for individual customers and are complicated by factors such as volume, aircraft size, FAA operating rules, time-of-day, chain and brand discounts, third party fuelers, frequent changes in cost, complexities surrounding taxes, and stale quotations. Today, FBOs have no effective means of managing and accurately disseminating these complex and ever-changing pricing issues.

Likewise, ACOPs have no means of receiving real-time updates regarding prices for fuel and ground services, and have no effective method to verify that the price charged or quoted corresponds to the correct price or formula as previously agreed between the parties.

The industry also lacks a useful solution to price quotations that have gone stale. Once the aircraft arrives past the quotation expiration date, the aircraft's operator is at the mercy of the FBO.

FBOs and other suppliers often purchase advertising in magazines and airport directories. Such methods are inefficient at best. No system exists that allows the aviation supplier to communicate a customized price, facility/service offerings, user ratings, user customized ads, and virtual tours at the exact moment the aircraft operator is considering the supplier's location or product.

FBOs lack an efficient means to develop a database of information about the frequency and patterns of customer flight and purchasing activities that could assist in developing both a marketing and pricing strategy. They also lack a means to track customer activity at their location for the purpose of determining ACOP visits to competitors.

Few tools exist to assist FBOs in determining how to price fuel to aircraft operators. For example, there are no effective methods to determine individual aircraft operator price elasticity across the spectrum of possible uplift volumes for myriad aircraft types and missions.

Once the supplier determines a price, no system exists that automates or assists in the process of an FBO responding to a price request with the attendant need for a tiered volume (uplift quantity discounts) strategy.

FBOs are often disadvantaged by industry practices, such as when suppliers transmit notification of fuel cost changes after the new price takes effect, thereby depriving FBOs of critical information. Price changes, if known in advance, could assist the purchaser in lowering inventory costs. In another practice, third party suppliers often deal directly with ACOPs, eliminating the FBO from the transaction, even though the aircraft is parked at the FBO's facility. In yet another disadvantaged practice, the industry uses an FBO rating system prone to biases analogous to “ballot stuffing” and sampling errors.

Once credit is granted, FBOs lack a cost efficient system for ascertaining on-going credit worthiness of aircraft operators. Also, pricing complexities and tax issues frequently result in delayed, and often incorrect, billings. These billing delays and errors can result in an inadvertent grant of credit beyond intended limits. All of these issues can result in payment delays. This is further exacerbated by aircraft operators ignoring payment terms with the knowledge a small FBO is unlikely to protest a slow pay.

Credit card merchant agreements require that the merchant (typically, the FBO) not decline acceptance of a card in favor of another card. This often results in the ACOP offering a more expensive card (in terms of processing fees) when the ACOP might have presented a less expensive card had he known the cost impact to the merchant (FBO).

Today, ACOPs suffer from a lack of trading tools similar to FBOs. However, systems do exist for scheduling and disseminating ACOP flight scheduling information. One such system is described by U.S. Pat. No. 6,353,794 and its continuation Pat. No. 6,754,581 (Blachowicz) which illustrates a means for ACOPs to track the status of events associated with operating an aircraft. However, this system requires the scheduler to fax, phone, or email service requests to suppliers, or alternately, requires the supplier to run a copy of the ACOP's software to monitor events. Blachowicz does not address the benefit or need to communicate the information to suppliers electronically while simultaneously integrating such information into the FBO's workflow. Blachowicz also fails to address a method for the ACOP to shop price or services, solicit dynamic pricing responses, electronically purchase services, or manage contractual relationships with suppliers. Further, Blachowicz affords suppliers no effective means to integrate and manage service requests from a plurality of users who may or may not actively employ a flight scheduling system.

Such systems have additional shortcomings. ACOPs need a more efficient means to solicit dynamic responses from multiple suppliers during the scheduling process. Kumhyr, in patent application Ser. No. 10/351,559 describes a negotiating method between pilots and FBOs but it is limited to aircraft and only addresses price bartering. Kumhyr does not take into account that most ACOP decisions regarding FBO choice are made based on existing relationships. When an ACOP is searching for a new facility, only highly price elastic buyers would consider just price. Most ACOPs consider facility and service ratings, location, credit terms, paperless transaction capabilities, and other variables not addressed by Kumhyr.

ACOP systems also lack a means to tie service requests into a billing and audit system. These systems lack the ability to combine detailed transaction reporting for aviation trip leg purchases with crew trip expenses outside the industry, e.g., hotel and meal expenses. The systems also lack a means to tie purchases to specific trips, creating what many ACOP accounting departments call “end-of-month” frenzy.

When aircraft operators transact business, they normally do so through a variety of credit cards and direct billing. This requires carrying multiple credit cards. Such a system is cumbersome. There is no effective means of receiving and consolidating real-time transaction reporting across multiple purchase mediums. Also, pilots must return with each receipt to compare against the charge on the billing statement. A labor intensive process then ensues, requiring each billing statement item be matched against the correct flight segment.

Today, aircraft operators have the ability to track flights but not ground events such as crew/passenger check-in and completion of service items such as aircraft pullout, limousine arrival, and lavatory cleaning.

Aircraft operators, especially those operating aircraft on lease back or managing aircraft for their owners, have no system to permit electronic scheduling of the aircraft by multiple users from multiple, remote locations.

ACOPs have no effective means to communicate empty seats to other organizations or individuals for in-house use, charter, charity, or reciprocity arrangements.

The events of Sep. 11, 2001 have had a lasting impact on both FBOs and ACOPs. As a result, heightened security measures implemented in the commercial airline (“carrier”) infrastructure have opened the doors to potential terrorist activities within our nation's less secure general aviation environment.

Many general aviation aircraft carry sufficient quantities of turbine fuel and have the necessary kinetic energy required to transform the airplane into an effective weapon against ground targets such as buildings or nuclear facilities.

A lone terrorist could charter such an aircraft, eliminate or disable the crew, and fly the airplane into any target. Worse, a coordinated effort of multiple terrorists could simultaneously destroy multiple targets throughout the United States. The effect on commerce and the general aviation industry would be devastating. Unfortunately, only a rudimentary system exists to thwart such an attack.

Currently, the United States, has approximately 5000 departure facilities for private aircraft compared to at least 444 commercial facilities used by carriers, yet the number of passengers traveling on private aircraft capable of causing catastrophic damage to ground “targets” is miniscule compared to the 650,000 million passengers traveling annually on carriers in the U.S. The cost of placing Transportation Security Administration (TSA) screeners and equipment into each of these facilities would clearly be prohibitive. As a result, current TSA general aviation security initiatives are far less comprehensive than what exists in commercial aviation.

Compared to commercial aviation, TSA initiatives are understandably limited. The Twelve Five Rule and Private Charter Rule call for passenger identification checks. Another initiative, The Report of the Aviation Security Advisory Committee Working Group on General Aviation Security, recommends: “Prior to boarding, the Pilot in Command should ensure that the identity of all occupants is verified, all occupants are aboard at the invitation of the owner/operator, and that all baggage and cargo is known to the operator.”

No system exists to monitor compliance with these initiatives. For example, charter pilots are placed in a difficult position when a customer invites another individual aboard just prior to departure.

A lack of support exists for crew members attempting to ensure the identities of passengers while away from their home base. Crew members can only visually check government identifications. Forged identifications are a distinct possibility. Currently, departure facilities have no electronic identification scanning devices connected to each aircraft operator's passenger manifest lists.

Government agencies such as NORAD, FAA, and TSA have no real-time means of identifying general aviation aircraft that pose an increased threat due to factors such as type of operation, passenger identifications, or operator background.

Departure facilities have no means of identifying crew members and passengers “invited” by owner/operators. Many general aviation departure facilities are located at commercial airports. There is no effective system for preventing persons from accessing the airport ramp who are neither crew members nor invited passengers.

Departure facilities and government agencies have no fast, effective system to disseminate reports on stolen aircraft, flight operations initiated without the knowledge of the owner/operator, or tips garnered through TSA's aviation hotline.

Departure facilities have no effective means of identifying passengers and crew members for non-security reasons such as enabling customer service personnel to recognize and greet crew or passengers.

Aircraft operators have no effective means of quickly and accurately identifying new passengers and have no means of transmitting secure crew/passenger manifest data to pilots and departure facilities without violating passenger privacy. For example, passenger additions faxed to a departure facility can be viewed by the facility's employees.

The general aviation industry lacks a secure platform and messaging system for exchanging information between aircraft operators, pilots, FBOs, TSA, and the FAA.

General Aviation lacks a system for monitoring owner/operator ownership changes (by make, model, serial number, and tail number) for aircraft capable of causing significant damage and loss of life by impacting buildings, facilities, or landmarks.

### SUMMARY OF THE INVENTION

In view of the foregoing considerations, there believed to be a need for a system-wide method for implementing a computerized market, information exchange, and security system, across the general aviation industry. Aviation suppliers and government agencies need a system that can collect, manage, and display data about aircraft flights, crew members, passengers, aircraft operators, and other aviation suppliers. Conversely, aircraft operators have a need for a system that can collect, manage, and display data about aviation suppliers and other aircraft operators. More specifically, there are needs:
to establish a low cost or no cost means for a computerized market, information exchange, and security system operating in a secure environment within the aviation industry;
to establish a more efficient method of trade between suppliers and aircraft operators;
to provide work flow tools that reduce labor costs and improve efficiency;
to enhance the passenger's trip “experience;”
to minimize or eliminate FBO customer service and line service mistakes;
to enable suppliers to better predict personnel and resource requirements;
to establish a computer means for aviation suppliers to efficiently market their facilities, fuel, and services direct to aircraft operators;
to establish a computer means for suppliers to gather information necessary to respond to price and service requests directly from aircraft operators;
to establish a computer means for aircraft operators to learn more about an FBO than its price. Facility, line service, customer service, brand of fuel, location, and insurance coverage are just a few of the things most aircraft operators would like to learn;
to establish a computer means to electronically link aircraft, crew, passenger preferences, and service requests to an integrated real-time display of incoming and outgoing aircraft coupled to a task queue generated by service requests received from customers on or off the platform;
to establish a computer means to link alert states to the service requests task queue;
to establish a computer means to minimize or eliminate customer service and line service errors;
to establish a computer means for suppliers to manage and accurately disseminate a multitude of complex pricing structures with a minimal amount of supplier labor;
to establish a computer means for a faster and more accurate method for suppliers to prepare and deliver invoices;
to establish a computer means for aircraft operators to ensure that the price charged is the same as price quoted or the same as the price previously agreed across a set of occasionally complex variables;
to establish a computer means to minimize errors involving taxes;
to establish a computer means for aircraft operators to locate suppliers and more efficiently determine accurate, up to date, supplier prices for fuel and services;
to establish a computer means for aircraft operators to efficiently assess the quality and value of facilities, products, and services offered by the supplier;
to establish a computer means to resolve price quotations that have gone stale;
to establish a computer means for FBOs and other suppliers to market their facilities, products, and services at the exact moment the aircraft operator is considering the supplier's location or product;
to establish a computer means for suppliers to identify crew members and passengers;
to establish a computer means for suppliers to communicate information about an aircraft's crew and passenger needs to affiliated suppliers at an aircraft's next stops;
to establish a computer means for suppliers to develop a database of information about the volume and patterns of customer flight and purchasing activities to assist in developing both a marketing and pricing strategy;
to establish a computer means to monitor customer activity at competitors' facilities;
to establish a computer means to assist FBOs in determining how to price fuel and services using information such as customer price elasticity and purchasing patterns;
to establish a computer means to permit suppliers to respond to a price request;
to establish a computer means to predict changes in a supplier's cost of fuel and provide a method to communicate that information to the supplier in a time frame that permits the supplier to make a purchase decision prior to the change in price;
to establish a computer means to include the FBO in transactions involving third party suppliers accessing aircraft through the FBO's facility;
to establish a computer means to rate facilities and services of both aircraft operators and suppliers that is not susceptible to “ballot stuffing” and allows a detailed analysis of the type of customer making such a rating;
to establish a computer means to enable credit providers to offer platform participants various interest rates and terms of repayment in a virtual or “cardless” system of payments;
to establish a computer means to share real-time payment and financial information about ACOPs among credit providers;
to establish a computer means to allow lenders to bid on all or portions of credit facilities required by platform participants;
to establish a computer means to distribute a platform participant's repayment of the debt created from the credit facility among the various vendors in a predetermined order, e.g., date of invoice plus terms on a “first in, first paid” basis;
to establish a computer means to permit platform participants to hedge the price of fuel;
to establish a computer means to archive all communications and transactions;
to establish a computer means to permit each supplier to select his preference as to purchaser's form of payment or type of credit card used when the purchaser indicates no preference;
to establish a computer means for ACOPs to combine the processes of scheduling aircraft with the tasks of researching suppliers' facilities, price, and service quality; of soliciting pricing and service responses; of transmitting service requests; of electronically purchasing services; of managing price agreements and of participating in all the other tasks and features available to ACOPs under this invention;
to establish a computer means for FBOs to share ACOP customer preferences so that the FBO acts as an extension of the ACOPs customer service department;
to establish a computer means for a participant to transact business on the platform without the need for others participants to be currently logged onto the system;
to establish a computer means for suppliers to participate on the system, communicating with aircraft operators without logging on to a customer's system;
to establish a computer means for matching aircraft (or passenger) trips and trip legs to purchases whether they are transacted in or out of the industry and for providing the ACOP with a real-time, detailed breakdown of items and taxes associated with each purchase, regardless of the form of payment used;
to establish a computer means for ACOPs to receive paperless invoices and fuel tickets;
to provide a computer means for ACOPs to control on a card by card basis, the type of purchase that can be transacted;
to establish a computer means for ACOP pilots to purchase fuel and services with a virtual credit card;
to establish a computer means for ACOPs to allow the system to select the form of payment which best suites a set of parameters controlled by the ACOP; and for the system to select which credit vendor's credit card to use if the selected form of payment is a credit card;
to provide a computer means for ACOPs to automatically switch to other credit cards when the primary choice of cards is over limit;
to establish a computer means for ACOPs to track, in real-time, ground events such as completion of line service tasks, limousine and catering arrival, and crew/passenger check-in;
to establish a computer means for ACOPs to allow multiple users of an aircraft to reserve and schedule that aircraft from remote locations;
to establish a computer means for ACOPs to communicate empty seats to other organizations or individuals for in-house use, charter, charity, or reciprocity arrangements; and a computer means for the users of those seats to reserve and if applicable, pay for same;
to establish a computer means for ACOPs and other approved users to track or locate an aircraft while in flight or on the ground; (Note: discuss BARR list in patent detail)
to establish a computer means for ACOPs to view information, including private pricing arrangements for non-participating suppliers;
to establish a computer means to increase the efficiency by which ACOPs communicate scheduling information and service requests to suppliers;
to establish a computer means to increase the number of suppliers to lower prices and increase services through increased competition;
to establish a means for suppliers to offer incentives to ACOPs and pilots;
to establish a computer means to provide a method to monitor the system for fraud or financial irregularities;
to establish a computer means to create a more secure operating environment for aircraft, crew members, passengers, airports, and the nation's infrastructure through a crew/passenger ramp access verification process and by transmitting to the departure facility, TSA, FAA, NORAD, and other appropriate government agencies, risk scoring algorithms that quantify the potential risk posed by the aircraft;
to establish a computer means for TSA, law enforcement officials, suppliers, and ACOPs to instantaneously share vital, time sensitive information relating to security issues within the industry; Note—reports on stolen aircraft, flight operations initiated without the knowledge of the owner/operator, or tips garnered through TSA's aviation hotline
to establish a computer means for operators of general aviation aircraft and other aircraft not departing through a Transportation Security Administration (TSA) controlled departure terminal to supply encrypted crew and passenger manifests consisting of government issued identifications, e.g. a drivers license, and/or biometric data to each of the aircraft's departure point facilities;
to establish a computer means for the system to assess the risk posed by ACOPs, crew members, passengers, and specific aircraft; Note:—ownership changes, operating history, etc.
to establish a computer means for departure facilities to identify crew members and passengers attached to a specific aircraft without violating the privacy of those individuals;
to establish a computer means to allow the user a choice between storing primary data on a centralized data base server cluster or in-house;

The foregoing objects and advantages of the invention are illustrative of those which can be achieved by the present invention and are not intended to be exhaustive or limiting of the possible advantages which can be realized. Thus, these and other objects and advantages of the invention will be apparent from the description herein or can be learned from practicing the invention, both as embodied herein or as modified in view of any variations which may be apparent to those skilled in the art. Accordingly, the present invention resides in the novel methods, arrangements, combinations, and improvements herein shown and described.

In one embodiment, the present invention is a service chain network coupled to a plurality of gateway terminals used by aircraft operators (ACOPs) and governmental agencies such as NORAD, FAA, and TSA. The service chain is populated by various suppliers of products and services related to the business of aviation. All service chain members, hereinafter portals or chain portals, participating on the system, are licensees of the software and hardware necessary to create and operate a portal. Portals are classified by types. Each portal classification is served by a unique set of software and hardware tools necessary to operate its portal type. All portal users are also licensees of the software and hardware necessary to operate a portal, and therefore are “trusted” users of the system. A gateway terminal is one or more computers and peripheral devices used by ACOPs and government agencies. All gateway users are also licensees of the software and hardware necessary to operate a gateway, and therefore, “trusted” users of the system. Each ACOP uses their gateway to integrate their aircraft scheduling workflow with the present invention's process of locating, arranging, and purchasing products and services from portals and non-participating suppliers. Each supplier uses their portal to market and sell products and services to ACOPs. They also use their portals to manage the workflow and transactions attendant to their operations. Governmental entities use their gateways to monitor the risk posed by ACOP activities and to communicate with ACOPs.

### BRIEF DESCRIPTION OF THE DRAWINGS

The foregoing and other features and advantages of the invention will be best appreciated with referenced to a detailed description of a specific embodiment thereof, when read in conjunction with the accompanying drawings, wherein:

FIG. 1 is a block diagram of a computer-based platform for facilitating information, security and transaction exchange in aviation in accordance with one embodiment of the invention;

FIG. 2 is a block diagram of an electronic fixed-base operator portal module in the platform of FIG. 1;

FIG. 3 is a block diagram of an aircraft operator gateway module in the platform of FIG. 1;

FIG. 4 is a block diagram of a third-party fuelers portal module in the platform of FIG. 1;

FIG. 5 is a block diagram of an ancillary service providers portal module in the platform of FIG. 1;

FIG. 6 is a depiction of the graphical user interface presented to a user of the fixed-base operator portal module from FIGS. 1 and 2 during a fixed-base operator set-up operation;

FIG. 7 is a depiction of the graphical user interface presented to a user of the fixed-base operator portal module from FIGS. 1 and 2 during a fuel cost calculation operation;

FIG. 8 is a depiction of the graphical user interface presented to a user of the fixed-base operator portal module from FIGS. 1 and 2 during a fuel tax entry operation;

FIG. 9 is a depiction of the graphical user interface presented to a user of the fixed-base operator portal module from FIGS. 1 and 2 which interactively permits a fixed-base operator to specify fuel pricing methods;

FIG. 10 is a depiction of the graphical user interface presented to a user of the fixed-base operator portal module from FIGS. 1 and 2 which interactively permits a user to post fuel prices to the platform of FIG. 1 and which includes a custom services pricing panel;

FIG. 11 is a depiction of the graphical user interface presented to a user of the fixed-base operator portal module from FIGS. 1 and 2 during a tax calculation operation;

FIG. 12 is a depiction of the graphical user interface presented to a user of the fixed-base operator portal module from FIGS. 1 and 2 which permits a user to input and display price arrangements with specific customers;

FIG. 13 is a depiction of the graphical user interface presented to a user of the fixed-base operator portal module from FIGS. 1 and 2 which allows a user to create pricing categories by FAA operating rules;

FIG. 14 is a depiction of the primary graphical user interface presented to a user of the fixed-base operator portal module from FIGS. 1 and 2;

FIG. 15 is a depiction of the primary graphical user interface presented to a user of the fixed-base operator portal module from FIGS. 1 and 2 with a flight information panel displayed in a lower portion thereof;

FIG. 16 is a depiction of the primary graphical user interface presented to a user of the fixed-base operator portal module from FIGS. 1 and 2 with a request information panel displayed in a lower portion thereof;

FIG. 17 is a depiction of the primary graphical user interface presented to a user of the fixed-base operator portal module from FIGS. 1 and 2 with a line service information panel displayed in a lower portion thereof;

FIG. 18 is a depiction of the primary graphical user interface presented to a user of the fixed-base operator portal module from FIGS. 1 and 2 with a trip sheet information panel displayed in a lower portion thereof;

FIG. 19 is a depiction of the primary graphical user interface presented to a user of the fixed-base operator portal module from FIGS. 1 and 2 with a pricing information panel displayed in a lower portion thereof;

FIG. 20 is a depiction of the primary graphical user interface presented to a user of the fixed-base operator portal module from FIGS. 1 and 2 with a notes panel displayed in a lower portion thereof;

FIG. 21 is a depiction of the graphical user interface presented to a user of the fixed-base operator portal module from FIGS. 1 and 2 during a fuel cost prediction operation;

FIG. 22 is a depiction of the graphical user interface presented to a user of the fixed-base operator portal module from FIGS. 1 and 2 during a price response generation operation;

FIG. 23 is a depiction of the graphical user interface presented to a user of the fixed-base operator portal module from FIGS. 1 and 2 which interactively permits a user to post fuel prices to the platform of FIG. 1 and which includes an aircraft pricing panel;

FIG. 24 is a block diagram of the aircraft operators gateway module in the platform of FIG. 1;

FIG. 25 is a depiction of the graphical user interface presented to a user of the aircraft operators gateway module from FIGS. 1 and 24 during an interactive scheduling operation;

FIG. 26 is a a depiction of the graphical user interface presented to a user of the aircraft operators gateway module from FIGS. 1 and 24 which interactively allows the user to specify trip information;

FIG. 27 is a depiction of the graphical user interface presented to a user of the aircraft operators gateway module from FIGS. 1 and 24 which interactively allows the user to select a fixed-based operator;

FIG. 28 is a depiction of the graphical user interface presented to a user of the aircraft operators gateway module from FIGS. 1 and 24 comprising a response window displayed upon initiation of a fixed-base operator search function;

FIG. 29 is a a depiction of the graphical user interface presented to a user of the aircraft operators gateway module from FIGS. 1 and 24 which interactively allows the user to inquire, evaluate, schedule, and transfer flight schedules and service requests to a fixed-base operator; and

FIG. 30 is

### DETAILED DESCRIPTION OF A SPECIFIC EMBODIMENT OF THE INVENTION

In the disclosure that follows, in the interest of clarity, not all features of actual implementations are described. It will of course be appreciated that in the development of any such actual implementation, as in any such project, numerous engineering and programming decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant fields.

Furthermore, for the purposes of the present disclosure, the terms “comprise” and “comprising” shall be interpreted in an inclusive, non-limiting sense, recognizing that an element or method step said to “comprise” one or more specific components may include additional components.

### System Description

Overall System

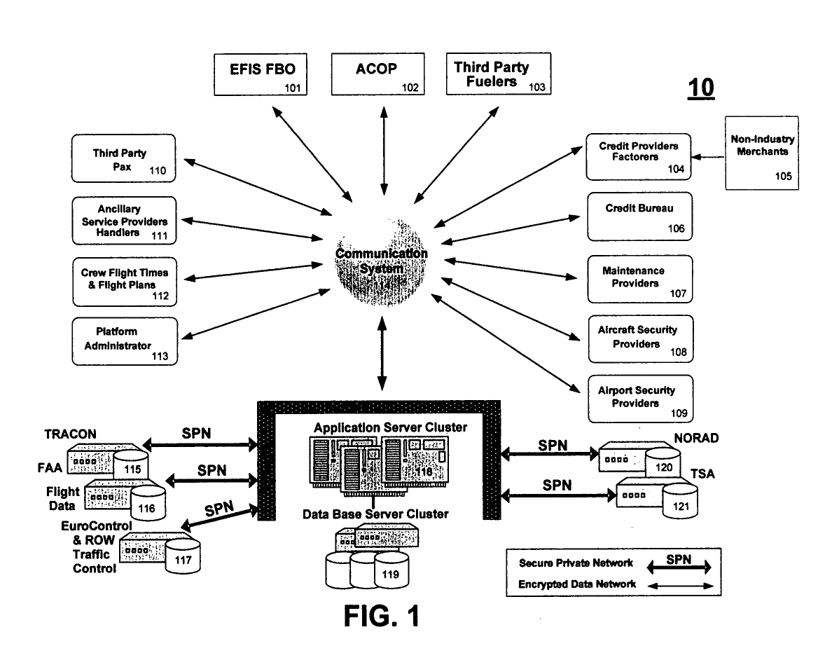

Referring to FIG. 1, there is shown a block diagram of an integrated platform 10 for facilitating an information, security and transaction exchange in the general aviation industry in accordance with one embodiment of the invention. As shown in FIG. 1, central to platform 10 is an application server cluster 118 and associated database server cluster 119 which serves as a central host/manager for transactions carried out on the platform and for information exchange between various participants and modules in the system. As can be seen in FIG. 1, application server cluster communicates via secure private networks (designated “SPN” in FIG. 1) with various governmental agencies, including, for example, North American Air Defense Command (“NORAD”) 120, the Federal Aviation Administration (“FAA”) 115, the Transportation Security Administration (“TSA”) 121, and others, as shown.

Application server cluster 119 also is linked to a communications system 114 via, in one embodiment, a high-speed communication link. Communication system 114 embodies any and all means of communication between participants and modules in platform 10, including, without limitation, satellite links, the Internet, and telephonic connections.

As can be observed in FIG. 1, communications system 114 serves to provide a communications link between various gateways and portals in platform 10 and application server 118. In particular, communications system 114 links an EFIS FBO portal 101, and ACOP gateway 102, a third-party fuelers portal 103, and a third-party PAX portal 110 to the application server 118. Additionally, other platform participants are linked to application server 118, including an ancillary service provider portal 111, a crew flight times and flight plans portal 112, credit provider portal 104, a credit bureau portal 106, a maintenance provider portal 107, an aircraft security provider portal 108, an airport security provider portal 109, and a platform administrator portal 113. The platform administrator portal 113 enables the operator of application server 118 to oversee operation of platform 10.

EFIS FBO Portal

Various components of platform 10 are depicted in FIG. 1. The primary portal type is the EFIS FBO portal 101. Each FBO portal 101 (and it is contemplated that a platform 101 will include a large number thereof) receives software and hardware designed to manage workflow, marketing, sales, inventory, pricing, and security in a unique way. The FBO portal is one of the key components of the present invention and is referred to as an Electronic FBO Information System, hereinafter “EFIS.”

In accordance with one aspect of the invention, EFIS FBO portal 101 is a supplier portal to enable FBO participants to integrate customer service requests into a combined workflow using task queues, to allow FBOs to market directly to their customers at the exact moment that the customers are making travel decisions. The EFIS FBO portal 101 further facilitates the dissemination of complex private and public pricing structures to both retail and wholesale purchasers.

In accordance with another aspect of the invention, EFIS FBO portal 101 manages inventory and fuel purchasing decisions by tracking inventory and predicting price changes before they occur. This is accomplished by means of software which tracks wholesale price changes and which utilizes mathematical prediction models and algorithms.

Further, and in accordance with another aspect of the invention, EFIS FBO portal 101 is integral to maintaining security at general aviation facilities.

By tracking buyer transaction activity and physical movements, platform 10 creates profiles of the customer's purchasing patterns and operating practices. This information is made available to suppliers to assist them in developing and customizing a pricing strategy for each specific buyer. The system then communicates a buyer's intent to visit an airport in a specific aircraft. This enables the supplier to respond with a combination of price, service, and facilities tailored to that customer's profile. For example, the system identifies price sensitive (price elastic) buyers and assists each supplier in providing competitive bids while isolating inelastic buyers (see the discussion of the Price Response Algorithm hereinbelow), providing them with higher levels of service and higher prices. The system converts FBO pricing from static (posted prices) to dynamic prices tailored to a specific customer's purchase patterns. This system could also be used in other industries such as transportation, medical, or almost any large scale retail or wholesale operation that involves tracking customer patterns or movements.

Platform 10 allows suppliers to “broadcast” prices and information to consumers in real time. The supplier can tailor these prices to the consumer, based on information about the consumer's operating and purchasing patterns provided by the data maintained on application server 118. The system displays this information on computer, cell phone, wireless PDA or other emerging technologies related to input/output devices.

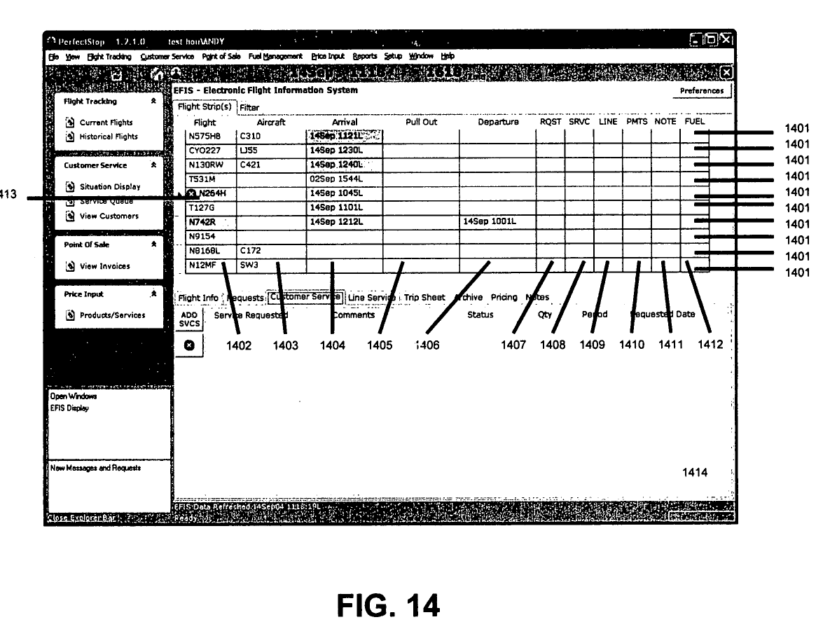

The primary EFIS display is depicted in FIG. 14. This display manages FBO workflow by combining items such as electronic flight tracking (real-time and historical), direct messaging (text, voice, and picture/video files such as AVI and JPEG), electronic arrival/departure “reservations/service requests,” manual “reservations”/service requests, pricing, user ratings, a price response generator, fuel up-lift prediction algorithms, ACOP crew, passenger, and aircraft preferences, aircraft technical details, payment history, crew/passenger pictures, time until arrival, planned departure time, estimated fuel on board, customer price elasticity, customer purchasing habits, pricing arrangements, service status, messages, and security data such as passenger manifests including accompanying biometrics, into an single, integrated workflow, display.

Referring to FIG. 14, the main EFIS FBO portal display includes one or more flight strips 1401 each corresponding to a planned or actual flight. Each flight strip 1401 comprises the display of a record containing a plurality of individual fields corresponding to various dynamic parameters of an aircraft's flight. The individual flight strips 1401 in the main EFIS display are created on one of several possible ways. First, the flight to which a given flight strip 1401 corresponds may have been created by an ACOP 102 which is either planning or conducting a flight. Alternatively, a flight strip 1401 displayed in the main EFIS display may correspond to a reservation received telephonically or electronically by the FBO. Further, a flight strip 1401 can be created by manual or automatic capture of flight tracking data for aircraft which have filed flight plans or are already underway. Finally, a flight strip 1401 may correspond to flight that has arrived at the FBO but was not previously captured by one of the other methods for flight strip creation. The fact flight strips 1401 can be created in numerous ways exemplifies the measure of integration achieved by the system in accordance with the present invention.

As can be observed in FIG. 14, each flight strip has a plurality of fields. A FLIGHT field 1402 contains the aircraft's tail number or international civil aviation organization (ICAO) identifier plus a flight number, e.g., DAL1525. In the presently disclosed embodiment of the invention, a color and/or some other visual identifier (e.g., an icon) is used to designate one of four conditions of the flight in question: either no reservation has been made, a reservation has been made but the FBO has not confirmed the reservation, a reservation has been made and confirmed, or the reservation has been canceled.

With continued reference to FIG. 14, another field in the flight strip 1401 is the AIRCRAFT field 1403, which identifies the aircraft make and model. Another field is the ARRIVAL field 1404, which indicates the planned or actual day, month and time that the flight has or is expected to land. Once again colors and/or other visual indicators are used in ARRIVAL field 1404 to indicate arrival status information, such as whether the aircraft has departed, whether a flight plan has been filed, the estimate time of arrival, and so on.

Similarly DEPARTURE field 1406 indicates the actual or planned day, month, and time that the ACOP expects to leave the FBO, with colors and/or icons signifying departure status information.

A PULL OUT field 1405 indicates the actual or planned day, month, and time, that ACOP expects the aircraft to be positioned for pilot prep and/or passenger emplanement.

The request (RQST) field 1407 provides a summary of the plurality of communications threads between the FBO and the ACOP, these communications threads including such categories as “Fuel and Ground,” “General Requests,” “Catering,” and so on. Color codes in RQST field 1407 can be used to highlight and identify the more urgent thread(s) at any given time.

The service (SRVC) field 1408 provides information about all FBO tasks and customer concierge service tasks not related to ramp and line services. In the disclosed embodiment, this field displays a single color to represent such information as whether the service is past due, whether the service is in progress, and so on. Similarly, the LINE field 1409 provides information about all FBO tasks that are related to line (ramp) services.

A PMTS field 1410 indicates whether billable items (i.e., items requiring payment from the ACOP) exist, and if so, whether or not those billable items have been included on an invoice. The PMTS field 1410 further indicates whether or not such invoice(s) have been paid. Colors and/or other visual indicia are used to indicate such information as whether or not billable items exist, whether payment has been arranged, and so on.

A NOTE field 1411 indicates whether or not the system contains data pertaining to the customer, its aircraft, its crew, and/or its passengers. The information is derived locally or communicated by other gateways or portals via platform 10. This information can be communicated via the color of the NOTE field 1411 as it is displayed to the user.

Finally, a FUEL field 1412 indicates whether or not an ACOP has requested fuel, whether the ACOP has been fueled, and if so, the volume of fuel provided.

It should be noted that in the preferred embodiment, a user can click on certain fields within each flight strip to access additional information and queues. For example, by clicking on RQST field 1407 in a given flight strip, the user is presented with the communication threads which pertain to requested service tasks, i.e., communications between the FBO and the ACOP. Similarly, clicking on the NOTES field 1411 in a given flight strip 1401 causes the user to be presented with flight notes, if any are present in the system, pertaining to the customer, aircraft, crew and/or passengers.

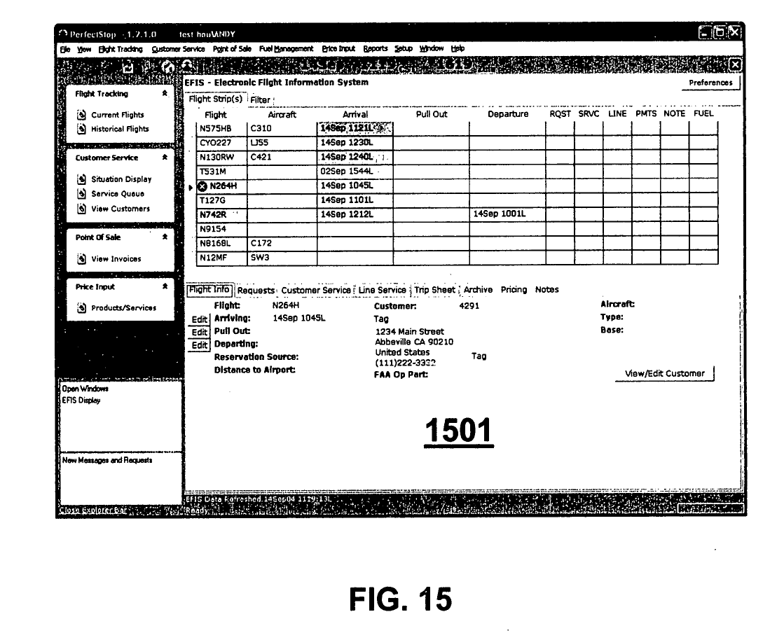

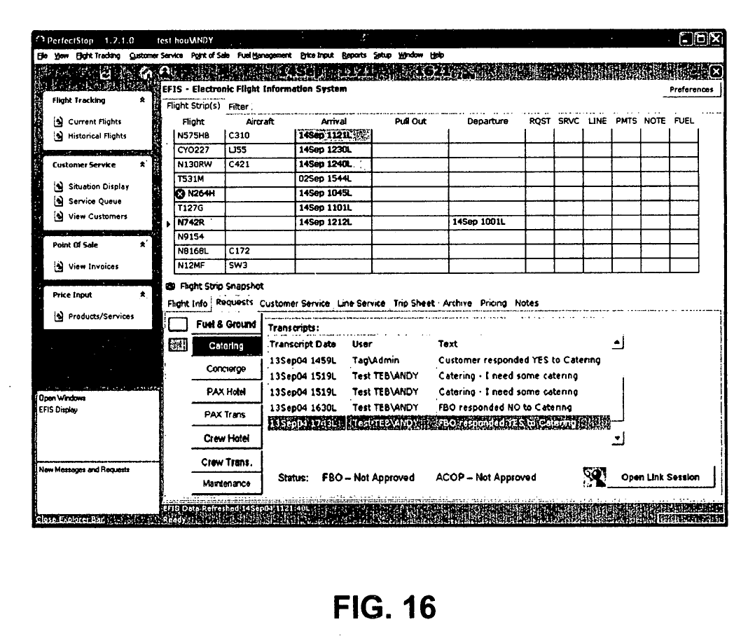

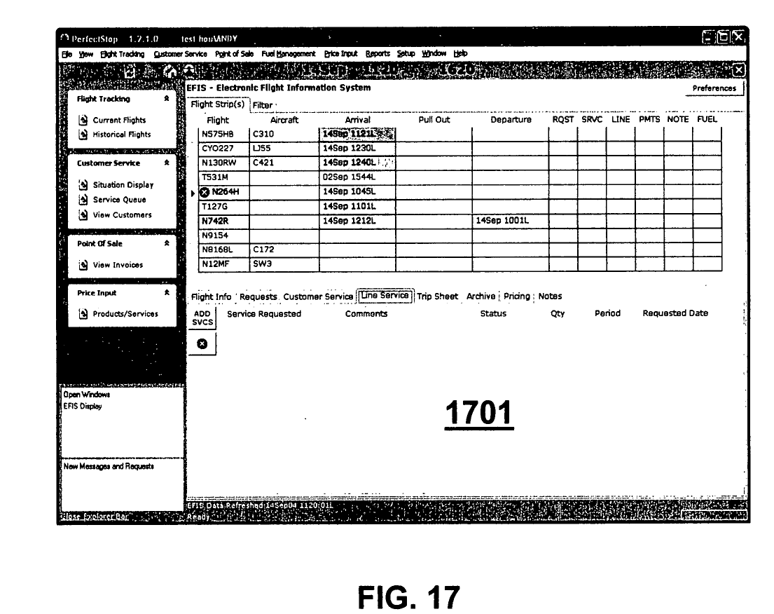

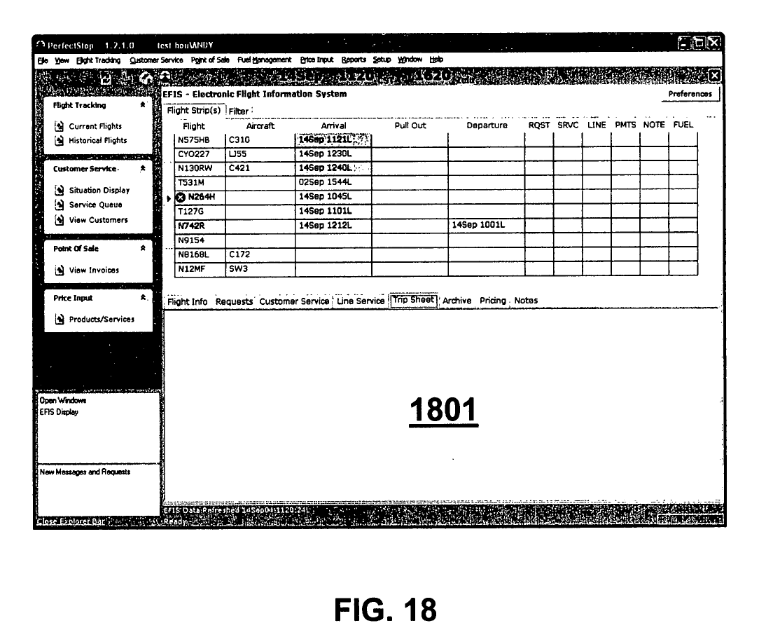

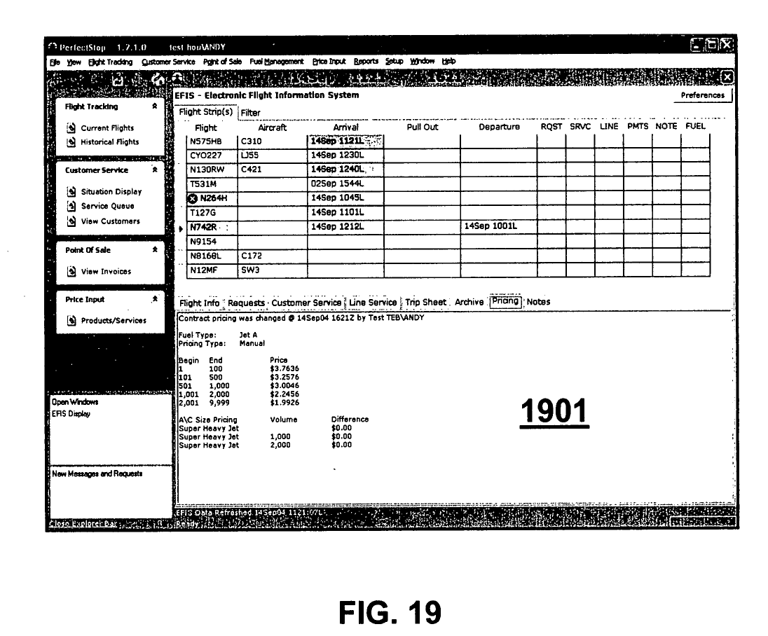

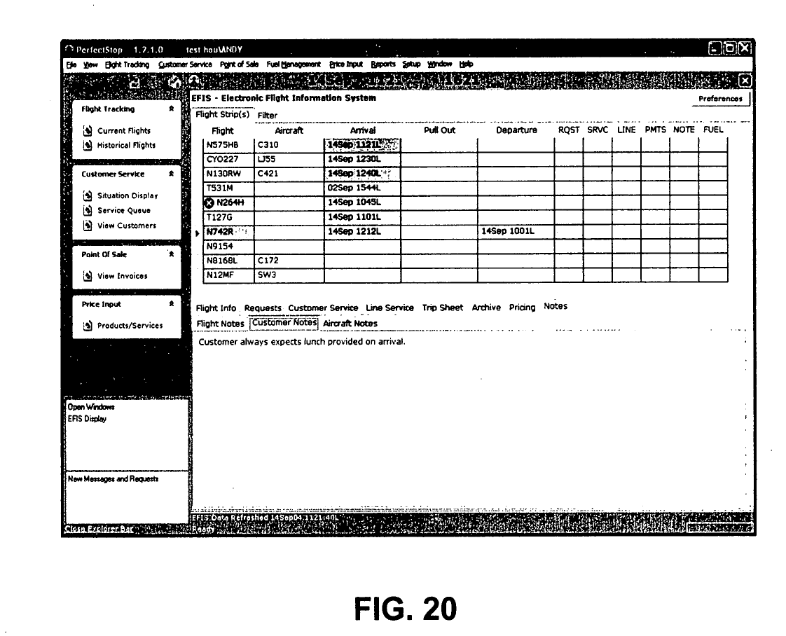

In another portion of the main EFIS FBO display depicted in FIG. 14, a plurality of tabs are provided for permitting the user to select from among various panels of information pertaining to a selected flight strip. A selection indicator identifies the selected flight strip. In the preferred embodiment, and as can be observed in FIG. 14, the panels of information include a flight information panel (designated with reference numeral 1501 in FIG. 15), a request-related communication threads panel (designated with reference numeral 1601 in FIG. 16), a customer service task queue panel (designated with reference numeral 1414 in FIG. 14), a line service task queue panel (designated with reference numeral 1701 in FIG. 17), a trip sheet panel (designated with reference numeral 1801 in FIG. 18), an archives panel, a pricing information panel (designated with reference numeral 1901 in FIG. 19), and a notes panel (designated with reference numeral 2001 in FIG. 20).

In the preferred embodiment, the archives panel displays all of the communications threads, quotations, and transactions combined into a chronologically ordered listing of items, thereby enabling the user to conveniently access all relevant information relating to a particular flight strip 1401.

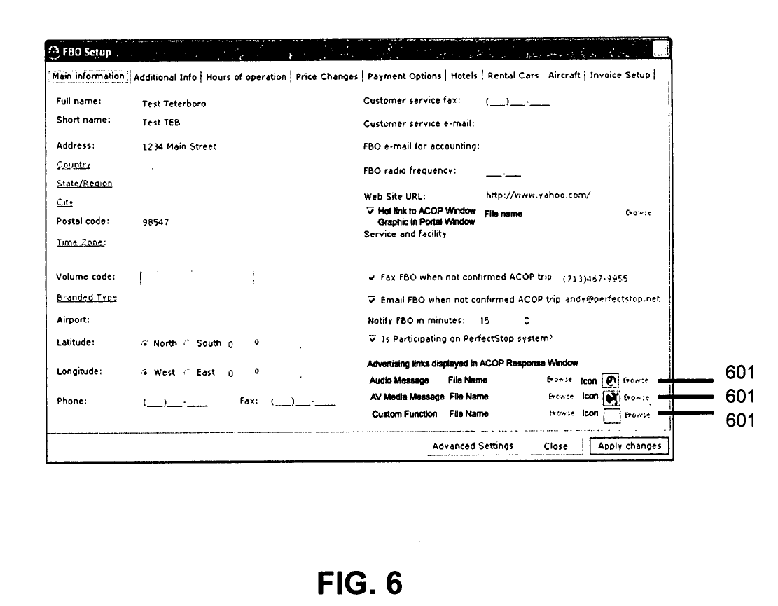

By integrating these features into a single EFIS FBO display such as depicted in FIG. 6, the system in accordance with the presently disclosed embodiment of the invention prioritizes time critical events and via the panel indicators, allows an aircraft fueler (FBO) to visualize work loads, minimizing the possibility a task will not be performed. The system also permits an electronic exchange of information on crews, passengers (Pax), and aircraft, e.g., pictures, identifications, security profiles and preferences. The system also identifies the aircraft owner/operator responsible for payment.

As previously described, flight information for each aircraft is placed in flight strips 1401 which are prioritized by adjustable parameters set by the FBO. The flight strips 1401 are then displayed in an electronic whiteboard fashion, similar to airline arrival and departure displays. However, as described above and unlike an airline arrival display, each flight strip 1401 includes panel indicators that alert FBO personnel of changes in the status of tasks related to the aircraft, passengers, crew, or payments.

By linking tasks to a real-time flight tracking feed, the system can prioritize tasks based on constantly changing arrival and departure information. Such a display format allows FBO personnel and ACOPs to quickly ascertain the status of services related to their aircraft. The panels also serve as an alert for incoming ACOP messages and requests. Each strip then acts as a gateway to the myriad information provided by the system about the flight, its aircraft, the ACOP, their crew and passengers, and associated service tasks.

The present invention also contains line service and customer service queues that hold service tasks for each aircraft. FBO users can then prioritize these queues in order received, task criticality, aircraft tail number, or other user defined criteria. Upon completion of the service item, the event is transferred to the invoice queue, ensuring the item is not accidentally omitted from the invoice.

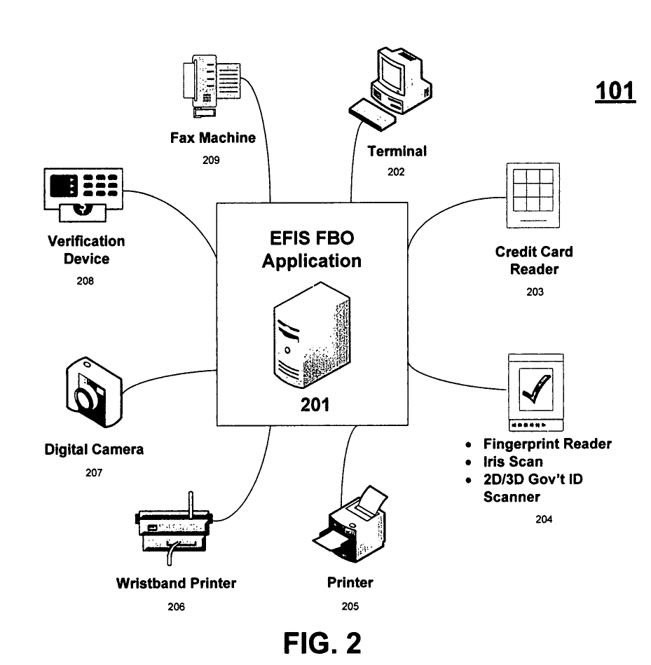

Turning to FIG. 2, there is shown a more detailed block diagram of the EFIS FBO portal 101 from FIG. 1. The EFIS FBO application, including all its accompanying modules, can reside on any computer 201, including personal computers, tablet PCs, PDAs, cockpit flight information systems, or cell phones that support connection to the Internet, telephone or satellite. The EFIS portal 101 permits aircraft operators (ACOPs) to initiate requests on their computers, cockpit flight information system, telephones, PDAs, or cell phones and transmit these to the EFIS service queues. It also allows the ACOP to monitor the status of these requests. Alerts and Messaging are integrated into the EFIS, indicating schedule, payment, and service problems. The EFIS also communicates with and supports credit card processing systems and a system known as a the EFIS Facilitator Module, designed to support open account (credit) transactions between the supplier (FBO/Handler) and buyer (ACOP).

With continued reference to FIG. 2, there are a number of components to a typical EFIS FBO portal. First, there is a terminal 202, preferably including a color display, for providing a user interface to the system. A typical system will also preferably include a credit card reader 203 for processing customer payments and/or retrieving ACOP credit card information.

One or more biometric reading devices, as well as appropriate government identification scanners 204 are preferably provided in an EFIS FBO portal to reliably identify passengers and crew members. In a preferred embodiment, a wristband printer 206 or radio-frequency identification device programmer is provided for uniquely identifying each passenger or crew member. Further, a digital camera 207 may be used to obtain identifying photographs of passengers and crew. Also, digital camera 207 can be used to present pictures of facilities to ACOPs and/or customers.

A verification device 208 is preferably provided for enabling crew members to confirm receipt of fuel and services. Finally, a fax machine 209 is provided to receive messages from the platform 10 should the FBO's primary electronic communications channels go offline.

### EFIS Pricing Module

The pricing module allows the FBO to store in both the portal's storage and the central database server cluster 118, its cost of fuel, taxes, and ACOP prices, e.g., Posted Price (General price quoted to no specific customer), Contract Price (Price agreed to between FBO and aircraft operator), Reseller Price (Price agreed to for a specific customer of a 3rd party fueler, a/k/a/ contract fueler), Reseller Special Price (Pricing for the customer of a 3rd party fueler), and Customer Price (Pricing strategies aimed at a specific ACOP in response to a request for price or as a means to entice that ACOP to land at the FBO's airport/facility).

The cost of fuel may be entered manually or formula pricing (e.g., Plafts or OPIS) may be selected (formula values are adjusted and broadcast by the system administrator when published changes are received). Pricing to customers is customized and may be based on selections such as Cost Plus, Manual, Discount to Posted Price, or Formula (Platts or OPIS). Pricing can be categorized by “all” FAA operating parts or any combination, i.e., 91, 91k, 135, 135-air ambulance, 135-air cargo, 121, and 125. It can also be based on type of aircraft. Pricing can include volume discounts e.g., 0-500 gls $2.35, 501-1000 gls $2.25, etc. (Note: volume tiers are adjustable and cumulative discounts are also available). The system also supports cross FBO chain cumulative volume discounts and supplier cumulative volume discounts. For example, cross chain discounts permit an FBO chain to offer a price discount for total volume purchased at all FBOs in the chain. Cross supplier discounts permit a 3rd party fuel supplier to offer cumulative discounts for customers who purchase the supplier's fuel at any participating FBO. Federal, state, local and airport taxes and fees are supported. In addition to fuel pricing, each category details ground service pricing.

Price changes, based on changes in cost of supply, are automatic, only requiring entry of product cost changes (usually once a week). The task is eliminated for FBOs that purchase fuel via formula pricing since the published formula amount is entered by the platform's administrator 113 (see FIG. 1).

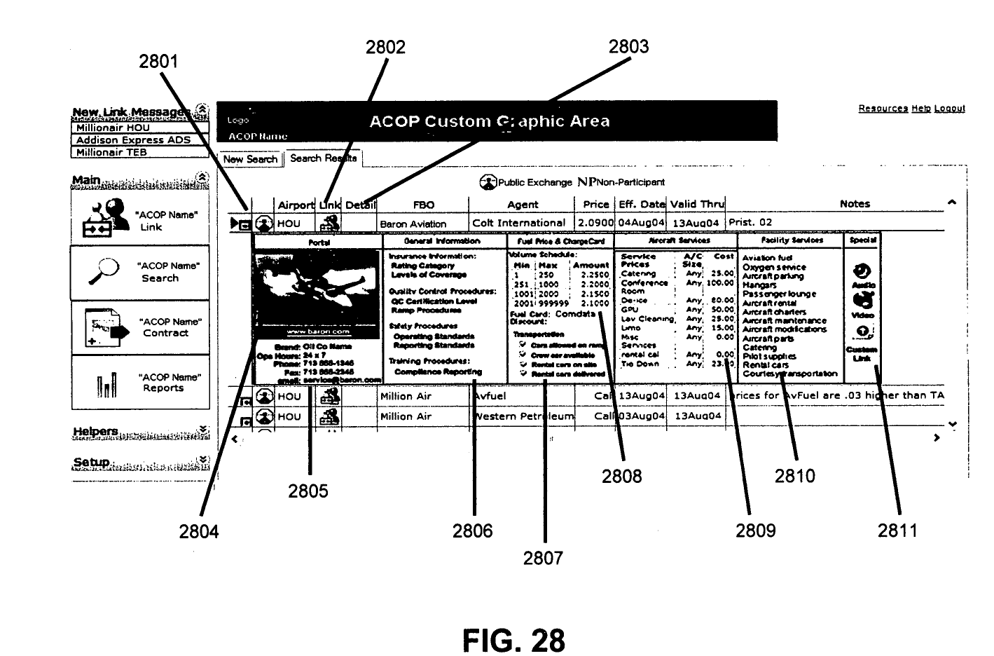

Price changes are instantaneously available to aircraft operators via the system (see FIG. 28) and can be automatically emailed or faxed to non-participants. All entries are archived and include date/time and enterer. Buyers are electronically notified of any supplier initiated price changes other than “agreed.” The present invention can then update and disseminate prices the moment costs, taxes, or desired profits change. This saves an enormous amount of labor and reduces errors significantly.

As discussed above, the module supports a Customer Price, i.e., a price derived from a strategy aimed at a specific ACOP in response to a request for price or as a means to entice the ACOP to land at the FBO's airport/facility. The system supports two Customer Price modes: Automatic and Manual. Under Automatic Mode the system utilizes the Price Response Generator to calculate a price offering. Under manual mode, the FBO user simply enters a price determined without computer assistance.

The system also allows the user to view competitor posted prices and provides average pricing not specific to any one customer.

### EFIS Price Response Generator Module

The Price Generator responds with tiered volume pricing by combining data generated by the Predicted Fuel Uplift Range Algorithm with multiple system data inputs that include an analysis of the ACOP's price elasticity based on analysis of purchasing history, likely responses from competitors (both on airport and nearby airports), predicted third party fueler responses, proximity of ACOP's point of interest (if known), predicted wholesale price changes, FBO peak/off-peak load considerations, crew incentive offers and their pattern of acceptance by the operator's crews, specific crew member purchasing patterns, the ACOP's historical use of the FBO's facility versus competitors' facilities, ACOP's buying patterns related to courtesy fuel and tankering, projected uplift quantities based on the predicted fuel burn for the specific aircraft and trip, buying patterns related to the operator's historical preferences for facility and customer service quality and how these relate to PAX on board/not on board, and FAA operating part scenarios. The user can determine which of these inputs are used and weight the significance the input has on the final price response.

In manual mode, the user can refer to the Price Response Graphic User Interface. Through this device, the present invention provides the user with a tactical representation of the ACOP's fuel buying situation. The Price Response Display shows recommended tiered volume pricing, typical courtesy fuel uplifts, estimated next leg fuel burn, min/max fuel possibilities, tank capacity. The display can also overlay the various input data it has been programmed to use or can use in making a decision in when in automatic mode.

### EFIS Competitive Tracking and Analysis Module

The competitive tracking and analysis module provides FBOs with information critical to analyzing ACOP purchasing practices and preferences. This is an important part of customer pricing and marketing.

One component of the invention involves the storing of live tracking segments. Stored data includes tail/flight number, date/time, and aircraft type. This technique serves as a first step in the process of creating a profile on specific aircraft buying patterns. It also permits users to replay flight activity for any aircraft for which flight tracking is permitted.

Another component compares aircraft arrivals at the FBO's airport to those aircraft that arrive at the FBO's facility. Logically, those aircraft that land but don't visit the FBO must have gone somewhere else on the field. After filtering aircraft based at the FBO and at other airport facilities, the system is able to report those aircraft that visited competitors. The system also differentiates between new customers and customer's aircraft that have transacted business in the past with the FBO. Once the system combines historical tracking data with system transaction data (e.g., quantity/price of fuel uplifts, type of operation, and crew member names), the platform is able to assist the user in generating either a manual or automatic response to future customer flights to or near the user's airport. The system can also assist the user in tailoring a marketing program to each prospective customer.

### EFIS Marketing Manager Module

The Marketing Module manages the process of marketing to ACOPs by generating and tracking marketing initiatives. The system allows the user to design and execute marketing plans aimed at one or more aircraft operators. The system can execute a wide range of marketing initiatives such as emails, faxes, system advertising, letters, phone calls, promotional material, gifts, discounts, frequent buyer awards, pilot greetings, price responses, and system messages. Referring to FIG. 6, the user can transmit some of these marketing initiatives directly to the ACOP gateway using links 601. The tracking system records the date/time and type of each initiative and links these efforts to purchases made by the ACOP that is the object of the initiative.

### EFIS Price Response Generator Algorithm

In accordance with one aspect of the invention, a methodology is supported whereby FBOs are able to determine of an optimum competitive price response to aircraft operator inquiries and/or requests for fuel and ground services.

The system uses data gathered from customer transactions to predict a visiting aircraft's possible turbine fuel uplift range. The Predicted Fuel Uplift Range Algorithm is as follows:
]F_{c}=Fuel Capacity of aircraft
F_{ob}=Fuel on board (last known)
Fᵣₛᵥ=Required fuel reserve (1:15 if not known)
F_{dfz}=Destination fuel w/0 fill at this location
F_{blk}=Fuel burn since last known
F_{bnl}=Fuel burn next leg (include Frsv)
F_{fh}=Projected high range for fueling
F_{fl}=Projected low range for fueling
F_{cf}=Courtesy fuel; any volume between 0 and ACOP stated courtesy fuel vol. for aircraft when Ffl=0.
F_{dfz}=F_{ob}−F_{blk}−F_{bnl}+uplifts since last known F_{ob} location
(note that F_{bnl} includes Fᵣₛᵥ. If next stop is not known, assume that the trip length equals that of the last leg. If length of the last leg is not known, use time-to-base. If the base not known, use 1:15. Note also that flight plans are a good source of information on destination and fuel on board.)
Ffh=F_{c}−F_{dfz}
Ffl=0−F_{dfz}; If F_{fl}<0; then F_{fl}=0

Examples of pricing strategies:

### EXAMPLE 1

Suppose that F_{fh}=2000 and F_{fl}=0; suppose further that the aircraft does not require fuel for departure. Therefore, the FBO should be sure to have minimum charge and set pricing high for courtesy fuel levels while significantly discounting volumes in the 2000 gallon range.

### EXAMPLE 2

Suppose F_{fh}=2000 and F_{fl}=600. In this case, the FBO should move the volume discount to 600+10%, then price for fill up (2000−20%) based primarily on pricing at next stop(s). Note that If (2000−20%) is <600+10%, then 600+10% should be used as volume break.

In accordance with one embodiment of the invention, the Price Response Generator, using the data generated by the Predicted Fuel Uplift Range Algorithm described above, preferably responds with pricing based on multiple system inputs that include an analysis of the ACOP's price elasticity based on analysis of purchasing history, likely responses from competitors (both on-airport and at nearby airports) and third party fuelers, proximity of ACOP's point of interest (if known), predicted wholesale price changes, FBO peak/off-peak load considerations, crew incentive offers and their pattern of acceptance by the operator's crews, specific crew member purchasing patterns, the ACOP's historical use of the FBO's facility versus competitors' facilities, ACOP's buying patterns related to courtesy fuel and tankering, projected uplift quantities based on the predicted fuel burn for the specific aircraft and trip, buying patterns related to the operator's historical preferences for facility and customer service quality and how these relate to PAX on board/not on board, and FAA operating part scenarios. Much of this information is supplied by the Competitive Tracking and Analysis Module described elsewhere herein.

Response Mode is determined in FBO Set-up. If an automatic response is generated by the price generator or standard auto response, this is indicated in the ARRIVAL field X4 of the flight's flight strip 1401. In the FBO set-up module, the user may view the suggested pricing structure. The user may then elect to transmit this price or adjust the price as desired.

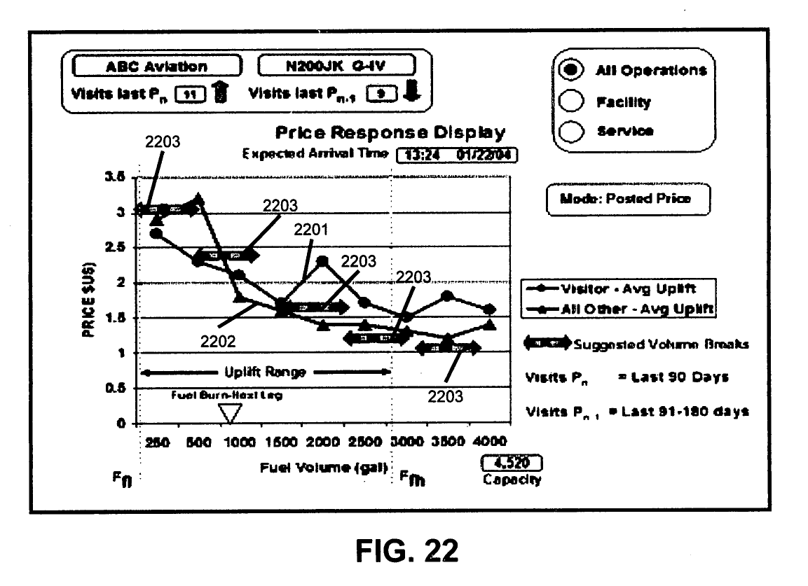

FIG. 22 depicts an example of a graphic presentation of the price response feature as may be displayed for the FBO. A graph of price (vertical axis) versus gallons (horizontal axis) is displayed, and two plots are presented, a first one 2201 representing the price that the visiting aircraft has paid historically at all FBOs which are part of platform 10, and a second one 2202 representing the price paid by all aircraft operators at all FBOs which are part of platform 10. Indicators 2203 of suggested volume discounts are then provided.

Preferably, the user can adjust the computer-inserted volume breaks horizontally or vertically which has the effect of changing the volume breaks and pricing response. These breaks are calculated based on the criteria indicated above.

The F_{bnl} triangle 2204 indicates the fuel burn projected for the next leg.

Price elasticity is determined by plotting the buyer's average fuel price against the distribution of all buyers' purchase prices. The plot slope creates a value coefficient which indicates the degree to which the aircraft operator will search for best service for lowest price and the average service/facility level used.

### EFIS Inventory Management Module

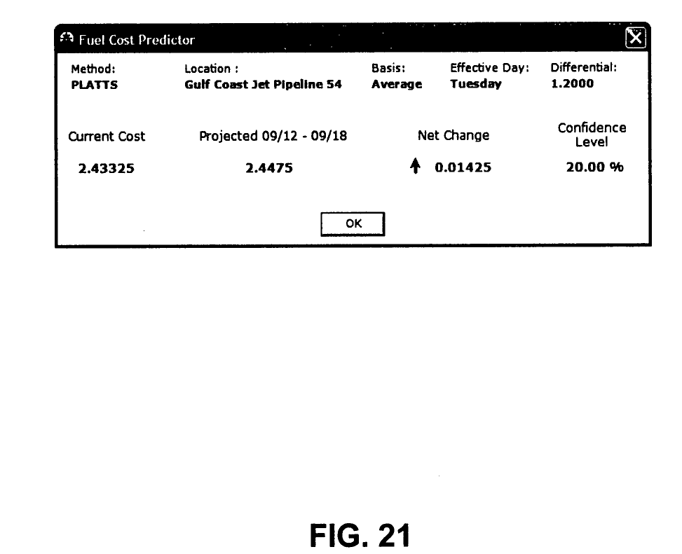

The inventory management module includes a virtual inventory system for fuel that manages fuel tickets and accounts for all gallons in the system. The inventory system is linked to the accounting system and supports radio frequency transmission of truck pumping activity. The module also employs a fuel cost predictor that forecasts changes in an FBO's cost of fuel prior to notification from the FBO's fuel supplier. An example of the manner in which the fuel cost prediction information is presented to the FBO is shown in FIG. 21. As a result, FBOs can execute purchasing and pricing decisions prior to notification of price changes, thereby lowering their average cost of inventory. Fuel purchases, from suppliers using published formulas, are projected into the following week based on daily price changes as quoted by industry accepted publishing services or daily changes in the front month New York Mercantile Heating Oil Contract adjusted for variations in actual bulk fuel transactions determined by a survey of industry brokers and transaction participants in various locations. Predictions are adjusted and updated daily. As can be seen in FIG. 21, a reliability co-efficient is also displayed. The Inventory Management Module also contains a fuel ordering system that links to both inventory management and can be driven by the fuel cost predictor.

### EFIS Facilitator Module

In one embodiment, the present invention incorporates a “facilitator” module for transactions involving direct credit between the supplier and customer. The system acts as a clearinghouse for payments made by customers to suppliers based on a first due, first paid basis or on an “as directed basis.” The platform provides suppliers with customer credit reports. The supplier's collection stature is significantly enhanced since customers are rated on how they pay both credit reporting vendors and all participating platform vendors. The system also tracks cross vendor detail charges, reduces payment errors, and details taxes and flowage fees allowing increased visibility of tax management.

In one embodiment, the platform administrator 113 (see FIG. 1) who is responsible for overall operation of platform 10 including application server(s) 118, assumes the role of a credit issuer, such that payments can be made by aircraft operators using a “virtual” or real credit card issued by platform administrator 113. Upon presentation of the real or virtual credit card for payment of an invoice, the platform 10 recognizes that the card was issued by platform administrator 113, and consequently routes the payment processing directly to the platform administrator and away from any general credit card processing system (e.g., Visa or MasterCard). This advantageously minimizes the credit card processing fees paid to third parties (i.e., parties not participating in platform 10 as a portal or gateway). Moreover, this maximizes the percentage of processing fees charged to the buyer that can be retained by the platform administrator 113 by virtue of it being a credit issuer.

In another embodiment, credit providers 104 (see FIG. 1), who are credit suppliers that participate in platform 10 as portals, may offer through the platform 10, to extend blocks of credit to participants in platform 10 at potentially favorable rates. This opens up the possibility for competition among credit providers who wish to reap the benefits of participating in platform 10 and the associated volume of credit extended as transactions are conducted on platform 10.

### EFIS Security Module

The Security Module assists the FBO in identifying departing crew/passengers by manual identification or in the preferred embodiment of using one of the security devices that read or input IDs or biometric data. The IDs are then automatically compared to the EFIS flight strip for a specific tail number's manifest transmitted by the ACOP. If the ID (in whatever format) fails to match the manifest, or if no manifest exists, the EFIS display and/or the device, responds with an appropriate warning. Otherwise a green indication is generated.

Optionally, the system can connect to a device that opens a gate or door to the ramp or prints a wrist band (normal or radio frequency) or other means of identification (containing items such as departure date/time, crew/pax name, photograph, and tail number) on a specific aircraft and matches these identifications with the crew/passenger manifest transmitted by the aircraft's operator.

The module also rates the arrival or departure via a risk scoring that quantifies the potential risk posed by the aircraft. This permits FBO personnel to conduct manual searches or take additional precautions in handling passengers and aircraft that receive a high risk score.

Operators of general aviation aircraft and other aircraft not departing through a Transportation Security Administration (TSA) controlled departure terminal, can supply crew and passenger manifests, consisting of various types of identification data (any combination of pictures, names, government identification numbers (IDs), (e.g., driver's licenses or passports), biometric data (facial recognition, fingerprint identification, retinal scanning and data from other emerging identification technologies), and customer preferences (e.g., full size car from AVIS waiting on the ramp, prefers fruit plate for lunch), to the platform's server 118 which in turn distributes the information to each of the aircraft's departure point facilities. This information is preferably transmitted using current encryption technologies. Since the information exists in an encrypted state, identities cannot be determined by personnel at the departure point. The system simply matches government IDs (e.g., passports or drivers licenses) to the encrypted manifest. This is one of the unique aspects of the invention. The system then assists these departure facilities in identifying departing crew/passengers by manual identification or by connecting to devices (fixed or wireless) that read or input IDs or biometric data. The IDs are then automatically compared to the EFIS flight strip 1401 for a specific tail number's manifest. If the ID (in whatever format) fails to match the manifest, this is indicated in some manner in the DEPARTURE field X6 of flight strip 1401. Otherwise the flight strip 1401 remains unchanged.

Once scheduled, passenger manifests are transmitted to a TSA system to verify manifest members are not on a terrorist watch list or have outstanding felony warrants. If not provided through a TSA system, the module will verify, by checking credit bureau data bases, the identity of these individuals.

Application server 118 then transmits to the aircraft operator, departure facility, TSA, FAA and other appropriate government agencies, risk scoring that quantifies the potential risk posed by the aircraft based on:
Government generated crew/passenger risk assessments such as CAPPS II or VISIT.
Risk scoring generated by crew/passenger credit bureau databases 106.
Aircraft operator risk assessments (operator history such as time in business, financial strength)
Type of flight (Federal Aviation Regulation (FAR) Part 91, 121, 125, 135, 91(k), etc.)
High risk passengers vs. low risk passengers/crew ratio (the likelihood that a high risk or unknown passenger could overpower the aircraft's low risk passengers and crew)
Aircraft operator familiarity with the crew member/passenger
Customer's form of payment
Departure facility screening compliance (were all passengers checked in? were high risk passengers checked for weapons? Bags checked?)
History of compliance by departure facility
Departure facility security level
Assessment of a specific aircraft's capability (fuel type, fuel quantity, and the aircraft's kinetic energy (the aircraft's maximum take-off weight (Mtow) times the aircraft's max operating speed (Vmo—red line for turbine aircraft or Vne—red line for piston aircraft) expressed as KE=(½Mtow)(Vmo²)) to inflict damage on a ground target.

The system analyzes real-time FAA flight tracking data, matches flights with risk scores and transmits this information to TSA, FAA, and other appropriate agencies. This provides air traffic control the ability to route the flight away from key locations such as nuclear facilities or urban areas.

Other factors can be added and the relative weighting of all these factors can be adjusted by the recipients of the data. Any changes generate an updated scoring coefficient. For example, as the aircraft progresses through its flight, the risk scoring coefficient reduces as fuel is consumed. Since the system knows fuel on board at departure, current fuel quantities are determined by calculating burn rates for that aircraft. Other factors, for example, that could change the risk assessment would be a last minute addition of a passenger.

The FBO, which is the typical departure point for a private aircraft, can use the information to identify crew members & passengers approved by the aircraft's operator and use these results to control access to the airport ramp and therefore, the aircraft. If a law enforcement agency or TSA determines that one or more of the individuals on the manifest is “of interest” or poses a risk, the system denies ramp access to that individual and “messages” the FBO to delay or prevent the departure of that aircraft until the appropriate authorities are satisfied.

Aircraft Operator (ACOP) registration on the system is transmitted to TSA for review. Each ACOP then adds aircraft (tail) numbers that they operate. The system then verifies that the ACOP name matches the owner of the aircraft per the FAA or foreign government aircraft registration database. If the name does not match, TSA or a monitoring entity is alerted for further review. Such a system allows TSA the opportunity to know the exact identities of aircraft operators and confirms the aircraft they operate.

The system utilizes the Alert and Messaging system to transmit this information to the FBO via the EFIS display. It can email or fax the information if the FBO's system is off-line or print, email, or fax the information if the system is on-line but not in display mode. The system also alerts FBOs as to stolen aircraft and other anomalies such as an aircraft that did not pay for fuel or an aircraft of interest to law enforcement (See Messaging and Alert System found in the “Both Supplier and Buyer Modules” Section).

Another component of the system involves publishing security ratings for FBOs based on levels of participation, compliance and additional security measures. These ratings can consist of any combination of standard grade/measurement representations such as color codes, letter grades, stars or numbered levels.

### EFIS Kiosk Module

In one embodiment of the invention, a Kiosk feature is implemented which allows a pilot to use the terminal as an ACOP Gateway.

Other EFIS modules contemplated by the inventors include conventional items such as flight tracking screens, full point-of-sale (POS) capabilities, a Reports Generating System that details FBO receivables, exports data to accounting systems, and provides numerous reports on FBO activities, including cross-chain reporting. The system also supports standardized modules such as maintenance programs and flight school management systems.

The ACOP Gateway

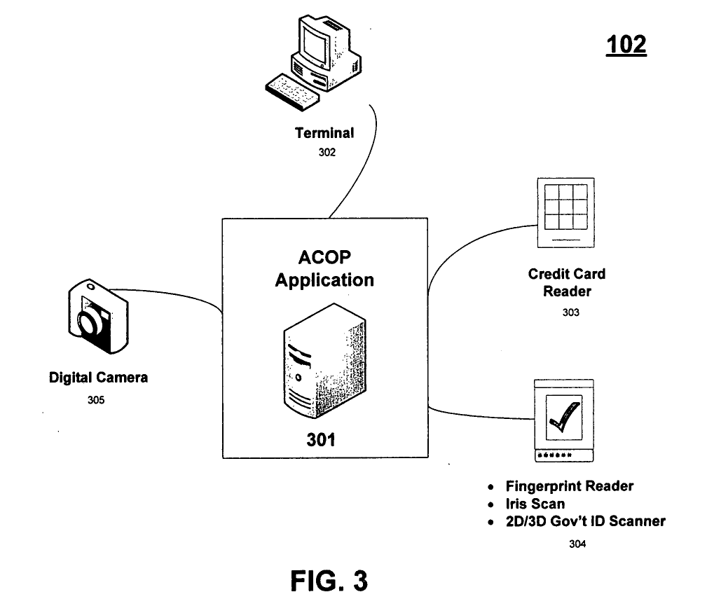

Turning now to FIG. 3, there is shown a more detailed block diagram of the ACOP gateway 102 depicted in FIG. 1. Like the EFIS FBO portal 101, the ACOP gateway 102 comprises a computer 301 and associated terminal 302 for executing an ACOP application and providing a user interface to the ACOP application, along with certain ancillary components.

In ACOP gateway 102, a credit card reader 303 is provided for capturing the aircraft operator's credit card data for processing payments in a virtual payment system.

Biometric reading device(s) 304 are provided for capturing and storing crew and passenger identities. Likewise, a digital camera 305 may be provided for security and customer service purposes. By having a photograph of passengers and crew, any portal in the system has the advantage of associating a name with a person, which can greatly personalize the travel experience.

ACOP personnel manage customer flight bookings and schedule aircraft trip legs that typically culminate at FBOs. This labor intensive process requires numerous interactions with FBOs and ancillary suppliers. The ACOP gateway improves upon these scheduling and trip management methods by electronically communicating scheduling, preferences, and requests to the FBO and ancillary supplier's task queues. This method enables the enplane/deplane location (FBO) to extend the passenger “experience” of flying on a private aircraft by integrating the information into the supplier's workflow, thereby minimizing the chance the request will be overlooked or miscommunicated. The gateway also offers buyers a novel way to purchase fuel and services by using the gateway to integrate these electronically communicated requests into an innovative transaction platform.

The ACOP gateway operates in two modes: 1) standard mode is a single program containing all ACOP gateway modules and 2) dual mode is an ACOP gateway operating concurrently with a third party scheduling program. In this mode, the gateway communicates data to and from portals by periodically vetting the scheduling product's database for additions and changes. Standard mode is the present invention's preferred mode of operation.

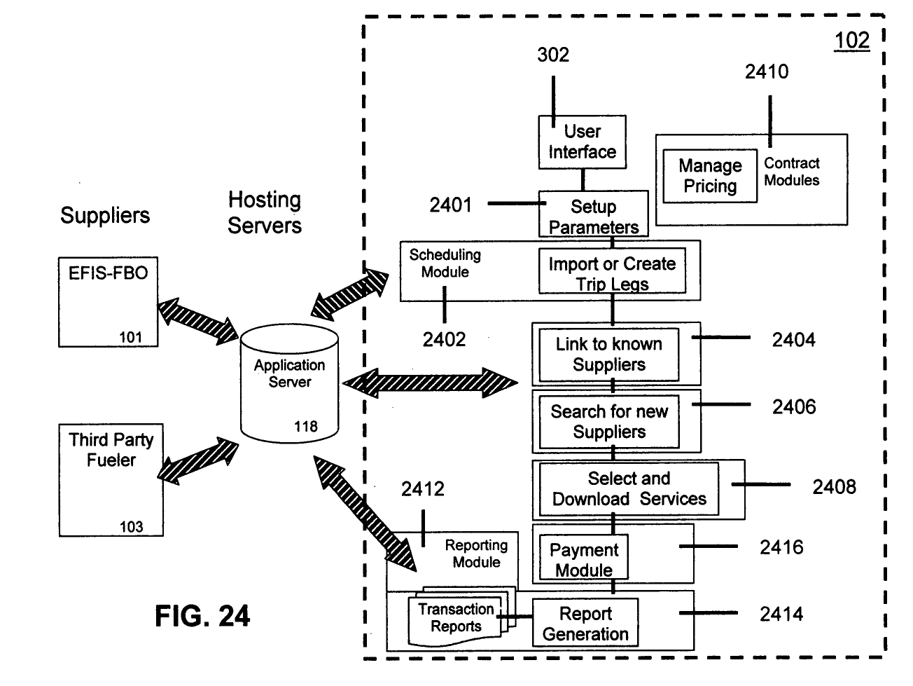

Referring to FIG. 24, architecturally, the ACOP gateway 102 interface consists of the following components:

A Scheduling application 2402 allows users to establish a series of “stops” for each aircraft. The system manages and tracks both aircraft and crew member scheduling. Scheduling application 2402 permits the operator to select a specific supplier at each stop, transmit reservations and service requests, lock in specific fuel and service pricing, and transmit encrypted passenger and crew manifests, including pictures, identification, (e.g., driver' license numbers, etc), to the arrival/departure facility. The scheduling application 2402 also receives real-time updates on service items, location, reservation confirmations, agreed pricing deviations, and the check-in status of passengers and crew. The system permits multiple aircraft operators, customers, and support personnel to share scheduling calendars in real-time. This same calendar supports and displays pricing, scheduling and reserving aircraft services through the calendar interface.

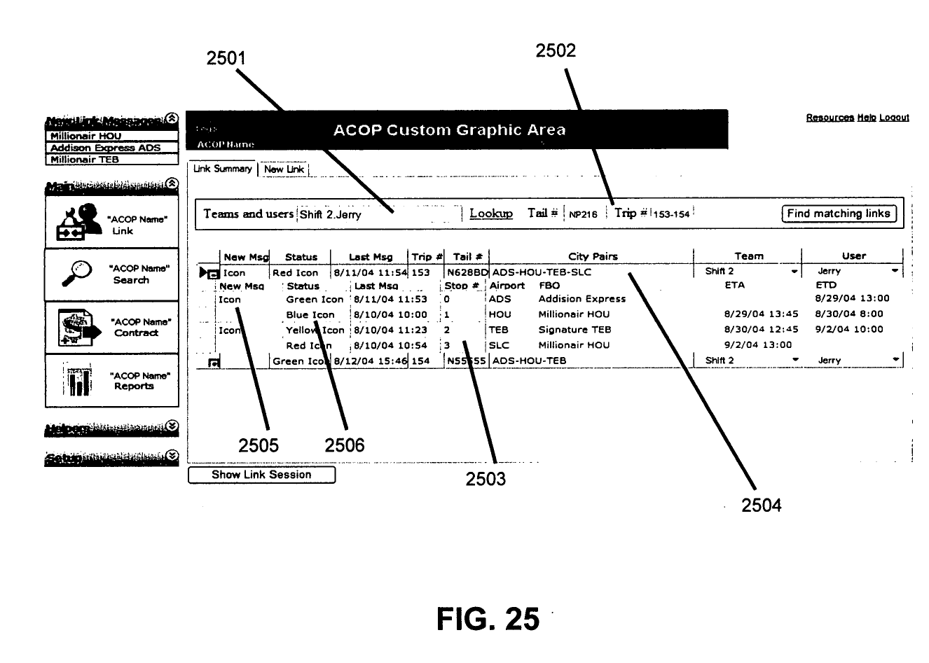

Referring to FIG. 25, which shows the scheduler's graphical user interface that is displayed to the user, the scheduler's first task is to define the trip legs (city pairs) 2504. Once the ACOP scheduler 2402 has determined an aircraft's trip leg(s), the user selects an FBO, at each trip leg destination airport. The system may be programmed by the ACOP to automatically select certain FBOs and ancillary suppliers at locations where existing preferences or pricing arrangements have been set; or the user can select suppliers through an active “links” window.

The ACOP scheduler 2402 works in an on-line collaboration environment where constant connection is maintained for selected FBOs through real time “link sessions,” also referred to as communication threads. Link sessions are created for each leg of the trip to the selected FBO. Once created the “link session” remains open throughout the duration of the trip. The sessions are ordered and summarized by Trip # and Tail #, which are displayed as indicated by reference numeral 2502 in FIG. 25. Presentation of trip information is distributed to appropriate teams and schedulers within the teams (displayed at reference numeral 2501). This summary creates the launch point in ACOP where the scheduler opens links to FBOs, defines the services required, and transmits service requirements electronically to the FBO. Each stop (FBO location) during the trip is recorded as a specific Stop # 2503 with a city pair 2504 either created by the scheduler or imported from a third party scheduling system. The Link Summary orders each leg of the trip and indicates messages received, as indicated by reference numeral 2505 in FIG. 25 from the selected FBO and the status 2506 of service requests communicated to the FBO. As requests are fulfilled, this information is entered into the system, for example through the FBO portal, such that all aspects of flight status can be monitored in real time by all parties.

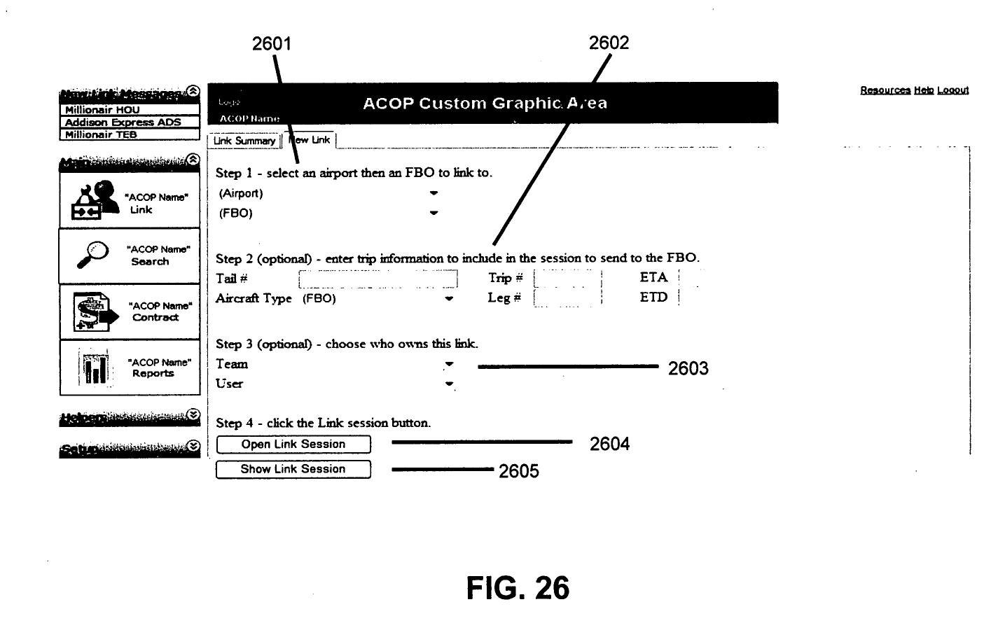

Referring to FIG. 26, a new trip leg 2601 is associated with an Airport ID and FBO ID. The ETA (Estimated Time of Arrival) and ETD (Estimated Time of Departure) 2602 is associated with the Trip # and Tail #. At any time during the trip, the scheduler may return to the link summary and open an active trip “link”.

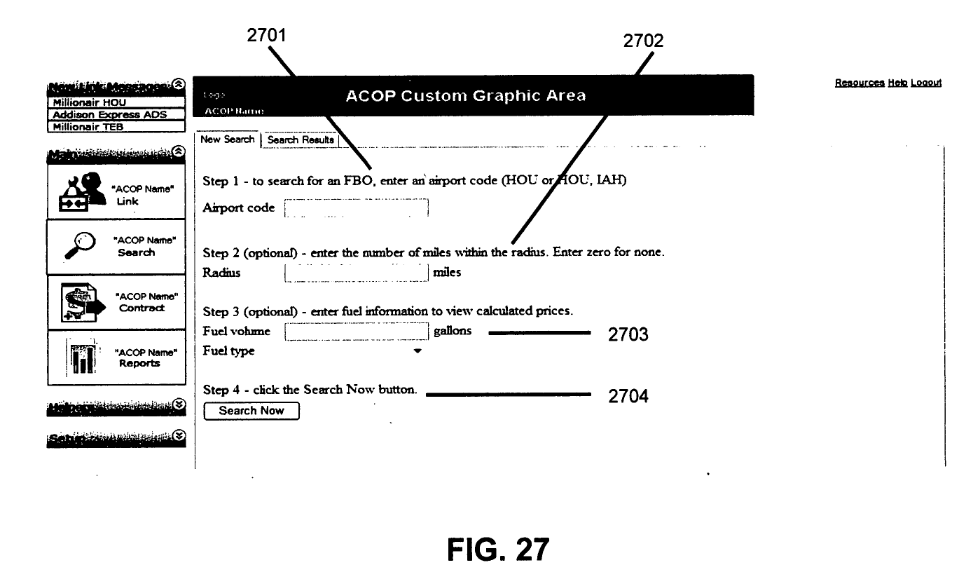

Turning to FIG. 27, a supplier “search” command allows the user to (1) evaluate suppliers on a trip leg basis, (2) rank suppliers according to predetermined criteria such as price, service, value, or facilities, (3) solicit specific responses based on passenger and operator specific needs, (4) negotiate pricing, and (5) provide pricing comparisons to current industry averages. The search function is initiated by entering the target airport code 2701 and, optionally, an expanded radius in miles 2702 around the target airport location. The system maintains a geographic data base of all airport locations position by latitude and longitude. Expanded radius search allows the scheduler to evaluated “nearby” FBOs that meet the trip criteria in an expanded geographic area. This allows the scheduler to “shop” for the best supplier.

The supplier “search” function provides a “response window” shown in FIG. 28, where a listing of Suppliers at each location are displayed in a tabular list 2801. A supplier is either registered on the platform's public exchange or is a NP participant. A registered supplier may either display basic information about their facility or expanded information which is indicated by a “details” checkmark 2803. When details are available, the scheduler may open an “active marketing window” to further assess the offering of the FBO. The system may present unique information in the “response window” related to the specific customer needs and existing contractual agreements. A real time inquiry link 2802 may be opened to the supplier to log specific questions or requests, or, the scheduler may view customer specific information about the supplier in the “response window.” Suppliers may utilize this window to display private and pertinent information unique to the customer's requirements. This information includes a active web link portal 2804, contact information 2805, general information for the FBO 2806, including information such as visit percentage, insurance coverage and safety ratings for each facility, ground transportation information 2807, private fuel pricing schedules and credit card information 2808, available aircraft services pricing 2809, and general facility services available 2810. The FBO may also create Audio and Video information, accessed at link 2811 that each supplier considers important to marketing their facility. The user sees messages, advertisements, or virtual tours of the supplier's facility and detailed ratings by customers of supplier facilities and customer service. Special offerings can be matched against the operator or flight department's unique requirements. The response window allows any portal to present the fuel, ground services, facilities, and customer services that “best fit” the ACOP's requirements for each flight leg. NP's (non participants) include FBOs not registered on the platform, or FBOs that have existing pricing arrangements with the ACOP but have not registered on the platform. ACOPs have no interactive access to NPs, and cannot send messages, create “links, or schedule services with these entities.

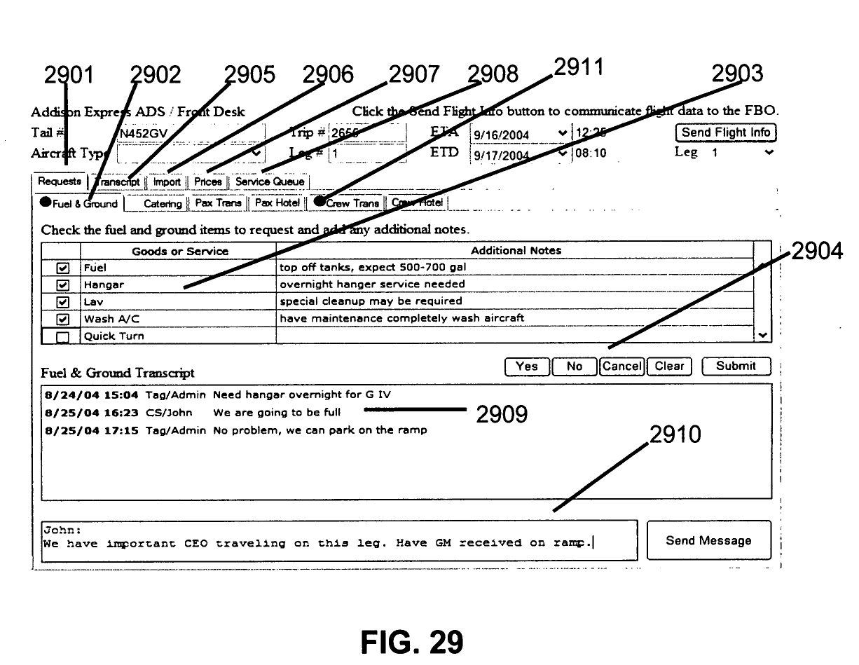

The trip leg “link” shown in FIG. 29 is used to inquire, evaluate, schedule, and transfers flight schedules and service requests to the FBO. All information associated with the trip leg is archived in the “trip record”. At any time prior to arrival, the scheduler may alter requests, change a schedule, or transmit a service request by clicking on Requests tab 2901. Requests may cover any functions or services required of the FBO (Fuel & Ground (tab 2902), Catering, PAX or Crew Transportation, or PAX and Crew lodging). Each service item is maintained within a “service folder” and contains a check mark 2903 to select the item, make notes, and submit 2904 for response. Every service request is electronically archived and displayed in a transcript window 2909 access by pressing tab 2905. Flight date, Time, ACOP ID, Supplier responder employee name, and confirmation note is logged in this window. Should there be a dispute later, every item of information relating to the service requests is available for review. The scheduler may also import information from the scheduling system “preference” files as well, by pressing the import tab 2906. Agreed pricing is noted in the “Prices” folder 2907. Once ordered, the status of services as they exist in the FBO's service queue 2908 are available for real time viewing. The service folder tab 2908 also supports an alert mechanism which is used to highlight the status of a particular service request (for example, yellow=pending, green=scheduled, red=not available). Messages between ACOPs and suppliers are also be communicated in real-time, as indicated at reference numeral 2910. In fact, messages can be exchanged between any system participants. If a portal is off-line, the system automatically sends a fax or email to the supplier containing the information. When the portal comes back on-line, the information is waiting in the supplier's task queue. Gateways receive confirmations via the system that the portal has received the communication. Like the portal, if the gateway is off-line, the system communicates to it via fax or email. The FBO selection also locks-in the price presented by the supplier. This is an important step in the process and is the basis for all transactions regarding the aircraft on this “stop.”

Once the aircraft arrives, the ACOP can monitor the current status of supplier tasks by viewing the EFIS FBO panel strip for the ACOP's aircraft. The FBO is primarily responsible for updating status information on the flight strip 1401, such as when particular events take place (aircraft arrivals and departures; service requests being fulfilled, and so on). As fuel volumes and service quantities are input by the portal operator, the ACOP gateway receives real-time reports on transactions in what is referred to as Level III detail, the line item breakdown of purchases and taxes. The information can then be downloaded directly into the ACOP's accounting system. Choice of payment is controlled by the Aggregator module.

The Aggregator module allows the ACOP to input and prioritize payment options. For example, the ACOP can specify the gateway to select “open account” if offered by a portal, otherwise use VISA card number 4265 xxx xxx xxxx and switch to AMEX 3765 xxxx xxxx xxxx if the VISA card goes over limit. The ACOP might also specify the VISA card be used on even months and a MasterCard be used on odd numbered months. The ACOP can allow the portal to choose the form of payment and can also direct that a specific credit card be used at certain locations. The Aggregator offers the ACOP one additional option. Lenders participating on the system can offer blocks of credit to the ACOP with varying terms. The ACOP can program the Aggregator under what circumstances such credit should be used.

Regardless of the form of payment selected, transactions between portals and gateways are Level III, paperless, and virtual. No credit card need be presented since the ACOP swipes the card using the gateway's credit card reader, thereby storing the card information in the system. At the FBO, a crew member enters a personal pin number to approve the quantity of fuel and services rendered. Price, of course, is not a consideration since that issue has already been electronically agreed upon. This process eliminates the need for paper invoices and supporting documents which the portal transmits to the ACOP electronically. Furthermore, off-platform ACOP charges are linked to a specific trip leg by matching the date/time of charge by a crew member's credit card to the aircraft he was assigned at the time of the charge.

Data stored in ACOP allows the aircraft operator to build a trip strategy, select FBO locations, view services and prices available at the various locations, and determine the most appropriate suppliers. Multiple trips may be displayed simultaneously so communications and events managed during the trip building process are always visible to the Operator.

ACOP gateways include flight tracking and resource management, and contain or integrate flight planning applications. All messages, requests, price quotes and transactions are archived for instant retrieval at any point during or after the trip. The ACOP may select primary data be stored locally on the gateway or on the central server.

The scheduler's first task is to define the trip legs. Once the ACOP scheduler has determined an aircraft's trip leg(s), the scheduler selects an FBO at each trip leg destination airport. The system may be programmed by the ACOP to automatically select certain FBOs and ancillary suppliers at locations where existing preferences or pricing arrangements have been set; or the user can select suppliers through an active “links” window.

The ACOP scheduler works in an on-line collaboration environment, depicted in FIG. 26 where constant connection is maintained for selected FBOs through real time “link sessions.” Link sessions are created for each leg of the trip to all selected FBOs.

In accordance with one embodiment of the invention, once created, the “link sessions” remain open throughout the duration of the trip. The sessions are ordered and summarized by Trip Number and Tail Number (see reference numeral 2502 in FIG. 25). Presentation of trip information is distributed to appropriate teams and schedulers within the teams identified, among other places, in the fields shown at reference numeral 2501 in FIG. 25. The Link Summary shown in FIG. 25 creates the launch point in ACOP 102 where the scheduler opens links to FBOs, defines the services required, and transmits service requirements electronically to the FBO. Each stop (FBO location) during the trip is recorded as a specific stop number, as exemplified by reference numeral 2503 in FIG. 25, with a city pair, as shown at reference numeral 2504 in FIG. 25 either created by the scheduler or imported from a third party scheduling system.

The Link Summary depicted in FIG. 25 orders each leg of the trip and indicates messages received, as shown at reference numeral 2505, from the selected FBO, and the status, as shown at reference numeral 2506 in FIG. 25, of services scheduled by the FBO. The system allows selection of indications (for example, “color” or “state icons”) to indicate current state. As the scheduling process changes from “request” to “schedule complete,” the indicator changes to denote the current state. Schedulers may handle a large number of trips; supervisors monitoring a group of schedulers require a mechanism to quickly assess the state of all trip schedules, and the system of the present invention provides a convenient means for so doing, since the Link Summary shown in FIG. 25 provides complete status of all trip leg schedules.

For any given trip, a new trip leg (see reference numeral 2601 in FIG. 26) is associated with an Airport_ID and FBO_ID. The ETA (Estimated Time of Arrival) and ETD (Estimated Time of Departure) (see reference numeral 2602 in FIG. 26) is associated with the Trip # and Tail #. At any time during the trip, the scheduler may return to the link summary and view an active trip “link”.

The supplier “search” module 2406 allows the user to (1) evaluate and select suppliers on a trip leg basis, (2) rank suppliers according to predetermined criteria such as price, service, value, or facilities, (3) solicit specific responses based on passenger and operator specific needs, (4) negotiate pricing, and (5) provide pricing comparisons to current industry averages. The search function, when initiated, presents the user with the screen depicted in FIG. 27. First, the user enters the target airport code at the field identified by reference numeral 2701, and, optionally, enters an expanded radius in miles at the field identified by reference numeral 2702, around the target airport location. The system maintains a geographic data base of all airport locations position by latitude and longitude. Expanded radius search allows the scheduler to evaluate “nearby” FBOs that meet the trip criteria in an expanded geographic area. This allows the scheduler to “shop” for the best supplier.

The supplier “search” function provides a “response window” where a listing of suppliers at each location are displayed in a tabular list, as shown in FIG. 28. A supplier is either registered on the platform's public exchange or is an NP (non-participant). A registered supplier may either display basic information about their facility or expanded information which is indicated by a “details” checkmark 2803. When details are available, the scheduler may open an “active marketing window” to further assess the offering of the FBO. The system may present unique information in the “response window” related to the specific customer needs and existing contractual agreements. A real-time inquiry link 2802 may be opened to the supplier to log specific questions or requests, or, the scheduler may view customer specific information about the supplier in the “response window.” Suppliers may utilize this window to display private and pertinent information unique to the customer's requirements. This information includes an active web link portal 2804, contact information for the FBO 2805 may be displayed, including general information such as visit percentage, insurance coverage and safety ratings for each facility. Likewise, information regarding ground transportation is displayed at reference numeral 2807, along with private fuel pricing schedules (reference numeral 2808) and credit card information, available aircraft services pricing (reference numeral 2809), and general facility services available (reference numeral 2810). The FBO may also create Audio and Video information accessible via a link 2811 that each supplier considers important to marketing their facility.

Information displayed in the response window shown in FIG. 28 is dynamically retrieved from each FBO's setup parameters and completely controlled by the FBO. The “response window” provides the FBO's unique facility characteristics and service offerings. The user may view messages, advertisements, or virtual tours of the supplier's facility and detailed ratings by customers of supplier facilities and customer service. Special offerings can be matched against the operator or flight department's unique requirements. The response window allows any portal to present the fuel, ground services, facilities, and customer services that “best fit” the ACOP's requirements for each flight leg. NP's (non participants) include FBOs not registered on the platform, or FBOs that have existing pricing arrangements with the ACOP but have not registered on the platform.

ACOPs have no interactive access to NPs, and cannot electronically send messages, create “links, or schedule services with these entities. ACOPs, being the demand point in the buying process, may request through messages and invitation transmittals that NP FBOs register on the platform in order to take advantage of a more integrated scheduling process through the buyer.

The Download Services Module 2408 (see FIG. 24) provides the collaboration between the scheduler and the FBO to request and confirm fuel and services. Each type of service is supported by an “active link”. Folders selected are highlighted and “state of events” within the folders is color coded for quick reference by the scheduler. The trip leg “link” is used to inquire, evaluate, schedule, and transfers flight schedules and service requests to the FBO. All information associated with the trip leg is archived in the “trip record”. At any time prior to arrival, the scheduler may alter requests, change a schedule, or transmit a service request.

Service requests may cover any functions or services required of the FBO (Fuel & Ground, Catering, PAX or Crew Transportation, PAX and Crew lodging, and so on), by accessing tab 2901 shown in FIG. 29. Each service item is maintained within a “service folder” and contains a check mark 2903 for “Goods or Services” to select the item, make notes, and submit for response. Every service request is electronically archived (the archive is accessed by clicking the “Transcript” tab 2905 shown in FIG. 29) and displayed in a transcript window 2909. Date, Time, ACOP ID, Supplier responder employee name, and confirmation note is logged in this window. Should there be a dispute later in the trip cycle; every item of information relating to the service requests is available for review. The scheduler may also import information from the scheduling system “preference” files as well. Agreed pricing is noted in the “Prices” folder 2907. Once ordered, the status of services, as they exist in the FBO's service queue 2908 are available for real time viewing. The service folder tabs also support an alert indicator, which is used to highlight the status of a particular service request Messages between ACOPs and suppliers are also communicated in real-time. Messages can be exchanged between any system participants. If a portal is off-line, the system automatically sends a fax or email to the supplier containing the information. When the portal comes back on-line, the information is waiting in the supplier's task queue. Gateways receive confirmations via the system that the portal has received the communication. Like the portal, if the gateway is off-line, the system communicates to it via fax or email. The FBO selection also locks-in the price presented by the supplier. This is an important step in the process and is the basis for all transactions regarding the aircraft on this “stop.”

Transcripts provide the basis for all data archiving in the system. The master “transcript” tab shows all communications between the scheduler and the FBO, irrespective of the specific item reference. Date, Time, Group, User, and data item are included with each transcript item entry. The system also provides a filtering tool allowing a view of the complete transcript, or filtered by category or date range. The active FBO Service Queue is displayed in the “Service Queue” tab.

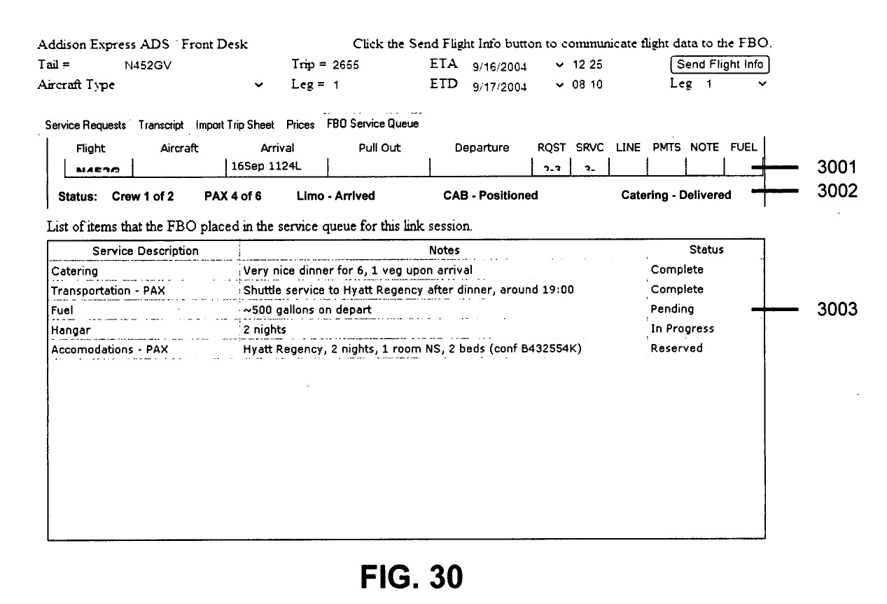

Referring to FIG. 30, the FBO Service Queue shows the status of all service items for this ACOP's flight. A “repeater” version of the FBO's flight strip 1401 on this flight is displayed along with a status strip 3002 that indicates the status of crew/pax check-in and key events such as arrival of catering and status of limousine service and the like. More detailed status information is found in box 3003.

A Contract Management module 2410 may be provided for both on-line pricing and aircraft operator private pricing structures. Registered FBOs define pricing structures with aircraft operators, automatically apply the pricing formulas to trip events, and notify the aircraft operators when pricing and/or terms change. This applies to both FBOs and resellers/contract fuelers. A summary of outstanding contracts and associated change status is presented in the FBO contracts tab. The supplier checks a box on their system when pricing or terms change and the operator has a corresponding box to check when the changes are agreed to. This collaboration ensures that no ad-hoc changes are made to prearranged pricing and terms agreements and is a basis for the system claim that “price agreed is price invoiced”. The pricing mode is also documented in a change summary. For example, the FBO might change the mode of pricing from cost plus to a formula price. Date and Period of effectivity is also noted in this summary. Custom ground and aircraft services may also be subject to a volume agreement or special pricing.

A custom pricing section documents special item pricing agreed upon between the Operator and the FBO. Volume pricing arrangements often are based on differential rates and extra charges. The complete schedule for the pricing is presented in the FBO contracts folder. The above pricing rules cover the usual forms of price extension by FBOs. Collecting pricing terms in a simple reference page that both buyer and supplier can review, change, and accept presents a unique level of collaboration in a real-time environment. Operator private contracts are tracked by the system for those FBOs and Resellers currently doing business with the Operator under some form of pricing agreement. Agent (Reseller) pricing is defined and listed by airport location as a purchasing option. In order for a Reseller to be registered at a particular FBO location on the platform 10, the Operator must “enable” system registration and the FBO must also “enable” registration for pricing to be displayed and processing to take place through the platform 10.

This process mirrors the existing business process commonly accepted in the industry but is not believed to have been ever integrated into an automated supply system. The form of payment is also defined allowing for electronic cardless payment if so designated. Standard credit cards may also be designated as a form of payment. The system also identifies specific cards approved for payment at any particular FBO or reseller. NP (non-participating) private FBOs may also be tracked under the private contracts section. All pertinent contact price, and terms information is recorded for reference purposes only. NP FBOs, however, may not (1) electronically process transactions, (2) publicize facility services and features in “response windows”, or (3) participate in real-time message collaboration with the Operator. If the Operator has maintained a pricing data base on an external website or by manual tracking systems, a data import option allows electronic transfer of the information into the system in order to initialize the operator specific “private” supplier data base. When a NP supplier registers on the platform 10, all collaboration services are activated and the newly registered supplier is headlined in the “search supplier” results as a registered supplier on the platform exchange. Pricing volume tables are summarized in the contracts “private pricing” folder, and displayed on search results in the response window, viewable only by the Operator owning the private relationship.

System wide Reporting Modules 2412 are provided to the ACOP through an extensive report generation module 2414. Reports may be defined and stored as templates for regular reporting and are utilized as an ad-hoc reporting platform. A report viewer tool may be provided to give a screen preview function allowing both viewing and printing of reports. A report filter tool may also be provided to allow the operator to build custom queries of the data base. Such a tool may allow the user to build custom reports by selecting data fields, report layout, sorting criteria, and grouping of information. Each report may be named, categorized, and stored as a template with reference to a particular data set. Such a reporting mechanism would allow the operator to build standard reports that include charges on- and off-platform charge through FBOs and resellers, and retail transactions (crew hotel, meal, and transportation charges) in a common report when posted through the a credit card issued by the platform administrator 113. FBO and reseller fuel and ground service charges are reported with line item details. Retail hospitality charges are reported in traditional retail card report format. The system collects all charges relevant to the trip on a leg by leg basis, and presents the activity through the reporting module.

Real-time flight tracking is integrated within the application and is selected through a “Helpers” main system menu. The flight tracking follows the “users” and “groups” display rules to indicate the trips assigned to each scheduler or group of schedulers. The flight tracking status display displays tail number, trip number, current location, ETA, days on ground, and date of last update. Schedulers or supervisors may add or delete flights from the active display list. When a trip is initiated or completed, application server 118 automatically adds or deletes the flight from the active display list.

Crew Expenses may be entered by pilot and crew members throughout the trip by accessing the on-line expense reporting facility. Crew members are presented with a Microsoft® Excel® spreadsheet (customizable by the ACOP) which documents the trip expenses. Users may access active reports by name, log expenses on each trip leg, post expenses, view, and print expense summaries. The expense summary is initialized with the Week Ending date, trip number, and crew ID. Multiple crew members (pilot and attendants) may create individual reports. Entry is provided for each day of the trip. An entertainment log allows recording of names/expenses for other individuals. The bottom line expenses are calculated and posted. The system adds crew expenses and status to the reporting system so that the accounting department can view all trip expenses in a composite view. A payment module 2416 supports automatic reimbursement of private expenses reported but not applicable or approved on the credit card issued by or on behalf of the platform administrator. Thus, all expenses applicable to the trip are reported and paid according to the business rules defined by the Operator's accounting department.

The payment module 2416 closes the cycle of processing by exchanging details of all transactions with line item details to the payment processor, receiving the authorization tags for all transactions and adjustments, and downloading information required to accurately match financial settlement with transaction reporting. The payment module 2416 includes the tools and services to electronically debit the account of the operator and extend payment to all suppliers registered on platform 10.

Regardless of the form of payment selected, transactions between portals and gateways are Level II, paperless, and virtual. No. credit card need be presented since the ACOP swipes the card using the gateway's credit card reader, thereby storing the card information in the system. At the FBO, a crew member enters a personal pin number to approve the quantity of fuel and services rendered. Price, of course, is not a consideration since that issue has already been electronically agreed upon. This process eliminates the need for paper invoices and supporting documents which the portal transmits to the ACOP electronically. Furthermore, off-platform ACOP charges are linked to a specific trip leg by matching the date/time of charge by a crew member's credit card to the aircraft he was assigned at the time of the charge.

Third-party Fuelers (3pF) Portal

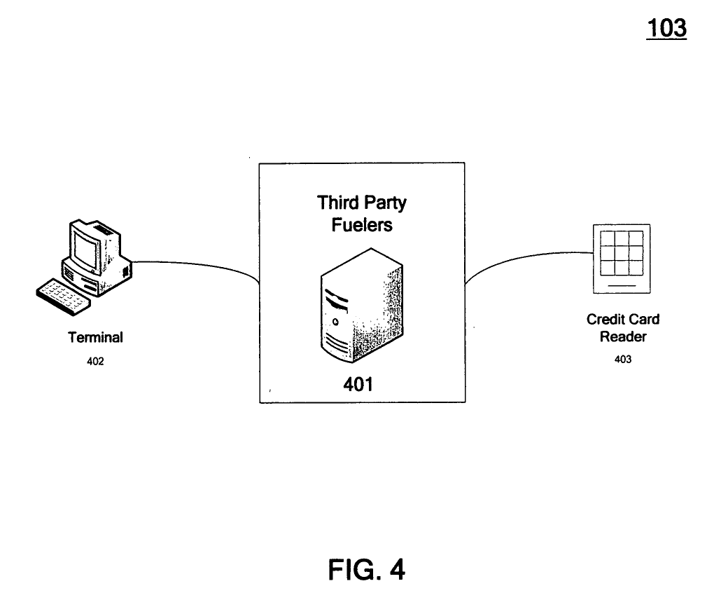

Turning now to FIG. 4, there is shown a more detailed block diagram of the third party fueler portal 103 from FIG. 1. Like the ACOP gateway 102, third party fueler portal 103 comprises a computer 401 and associated terminal 402 for executing a third party fueler application and providing a user interface to platform 10.

Portal 103 further comprises a credit card reader for processing payments from customers (aircraft operators and ACOPs) for fuel and services.

When scheduling an aircraft to an FBO portal, ACOP gateways transmit requests to 3pF's that are approved to conduct business at the FBO. A Third Party Fuelers (3pF) Portal Modules respond to ACOP gateway requests by receiving real-time pricing from FBOs and adding the 3pF's desired profit margin. The modules then transmit the final price to the ACOP gateway via the communications system. The module also supports messaging between all participants.

In accordance with one aspect of the invention, the 3pF pricing is transmitted to the application server 118 for display on ACOP response screen (such as is depicted in FIG. 28) that is presented to ACOPs making requests or inquiries for fueling at a specific FBO and airport. This is significant inasmuch as it takes into account the possibility that a 3pF's costs and profit margins may vary between FBOs, even at a single given airport.

Third-Party Pax Gateway

ACOPs, during the scheduling process, designate seats on specific legs as available to certain passenger classifications. The 3^{rd} Party Pax Gateway allows participating organizations to query the system looking for flights offering these seats. Scheduled flight times and equipment types are all made available to the qualified organization who can immediately book the seat through the gateway, much like booking an airline reservation. Payments, if applicable, are transacted through the system, gateway to portal.

Ancillary Provider Portal

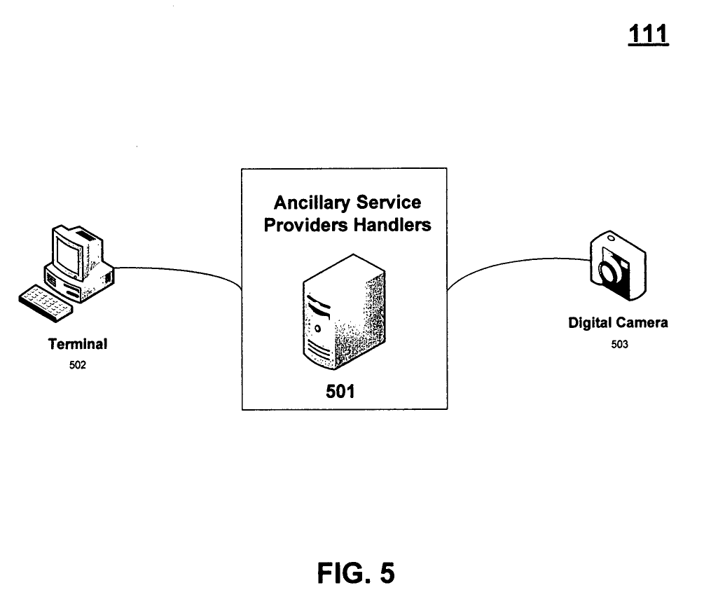

Turning now to FIG. 5, there is shown a more detailed block diagram of the ancillary service providers portal 111 from FIG. 1. Like the ACOP gateway 102, portal 111 comprises a computer 501 and associated terminal 502 for executing an ancillary service provider application and providing a user interface to platform 10.

The Ancillary Provider Portal (APP) Modules respond to ACOP requests for information with pictures and service descriptions. APP modules also respond to specific service requests with pricing, list of deliverables, and delivery timing confirmations. APP modules also communicate this information to the FBO if deliver to the ACOP through the FBO's facility. When scheduling an aircraft to an airport, ACOP gateways transmit requests to appropriate APP's serving that airport. If the FBO is known, the requests are limited to those APPs that are approved by the FBO to conduct business through their facility.

The Credit Provider Portal

Credit Provider Portals permit participating credit card providers to allow the ACOP gateway direct access to credit card privileges and limits. The ACOP can adjust via the ACOP gateway, within a credit provider determined range, the spending type and limit for a card. Furthermore, portals recognize the proprietary nature of the provider's credit card and divert the transaction, if applicable, from the issuing bank, e.g., Visa or MasterCard, to the credit provider. Note, credit cards on the system can be virtual, therefore, there may be no number or physical card.

Credit provider portals also allow the ACOP via the ACOP gateway, to request lines of credit from the credit card providers (factorers). The portal's software displays these requests to all portal participants for a bid. If the factorer is chosen, his line of credit is made available to the ACOP “form of payment.

The system also incorporates a “facilitator” module for transactions involving direct credit between the supplier and customer. The system acts as a clearinghouse for payments made by customers to suppliers based on a first due, first paid basis or “as directed basis.” The platform provides suppliers with customer credit reports. The supplier's collection stature is significantly enhanced since customers are rated on how they pay both credit reporting vendors and all participating platform vendors.

### Graphical User Interface

In accordance with one aspect of the invention, users interact with the EFIS FBO portal 101 and ACOP gateway 102 via a graphical user interface. The following briefly describes some of the screens that are presented to users during normal operation of the system:

FBO Setup (FIG. 6)

The FBO Setup window shown in FIG. 6 provides the user a means to input the unique information about his FBO. The main information page includes general details such as name, address, location, phone numbers, and time zone. More specific information is also supported such as volume codes, branding affiliation, and web site address. Tabs are provided to call up additional dialog windows allowing the user to specify such information as its hours of operation, pricing, payment options, hotel rates in area, rental car rates in area, aircraft definitions, and so on. Finally, “Is participating on the platform's system?” allows the user to take the FBO off-line in case of an emergency or error situation.

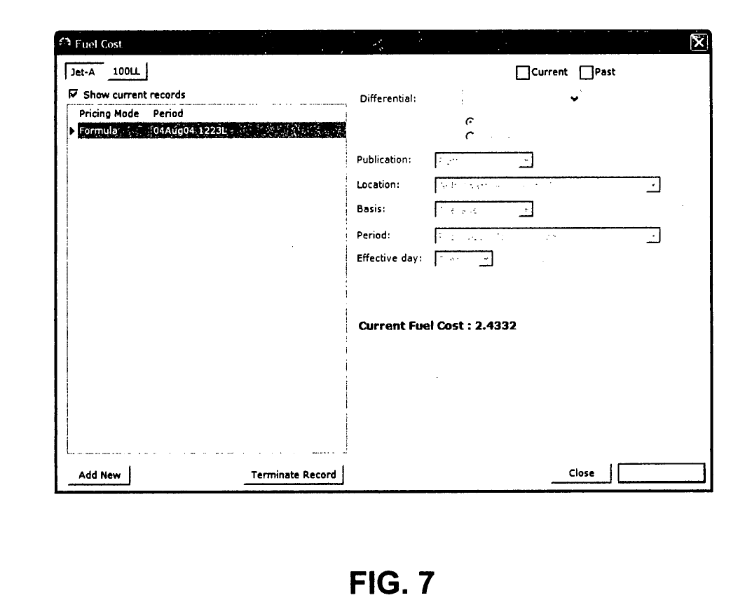

FBO Pricing Module Fuel Cost Input Screen (FIG. 7)

This screen represents one manner in which the cost of fuel can be entered by an FBO in connection with the Fuel Cost Pricing Module described hereinabove: As shown in FIG. 7, the FBO enters a formula-based method for purchasing jet fuel.

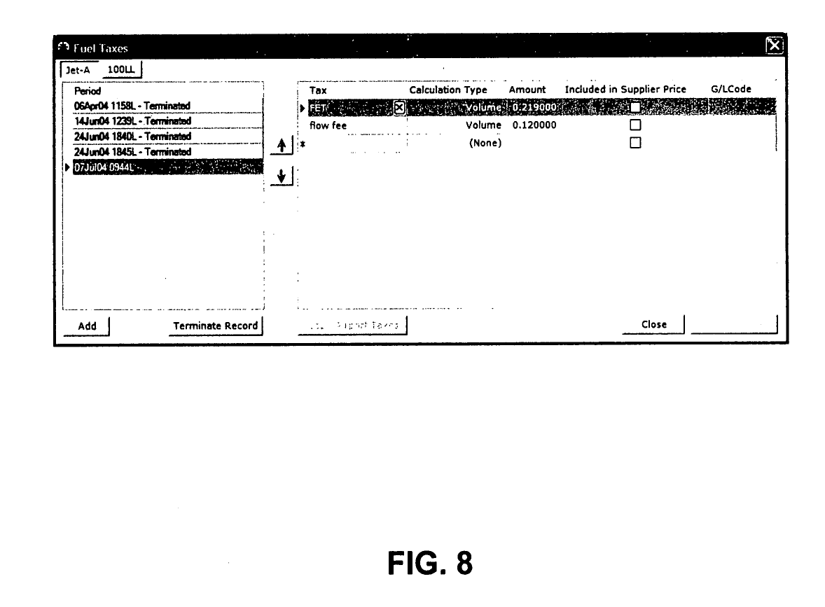

Fuel Taxes (FIG. 8)

Fuel taxes are entered in the screen shown in FIG. 8. Taxes can be entered in terms of volume, percentage, or flat-rate. The system also allows the user to determine the order in which the taxes are charged. Finally, the user can specify whether a tax is included in the supplier's price.

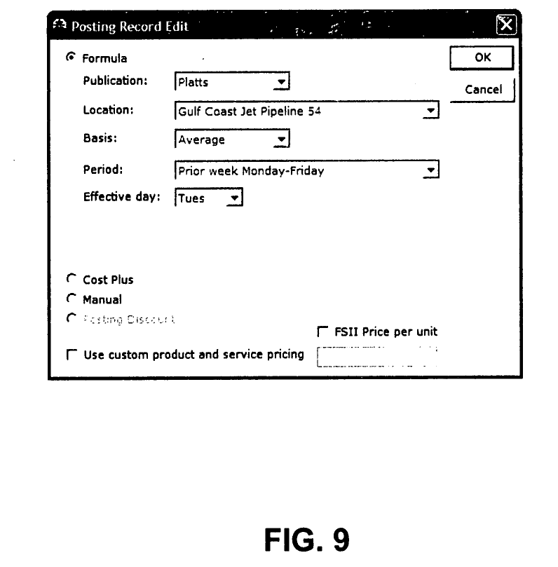

Fuel Posting Record Edit (FIG. 9)

FIG. 9 is an example of a price entry screen which enables the FBO to input various pricing methods, for example, formula, cost-plus, manual, discount to posting, and so on.

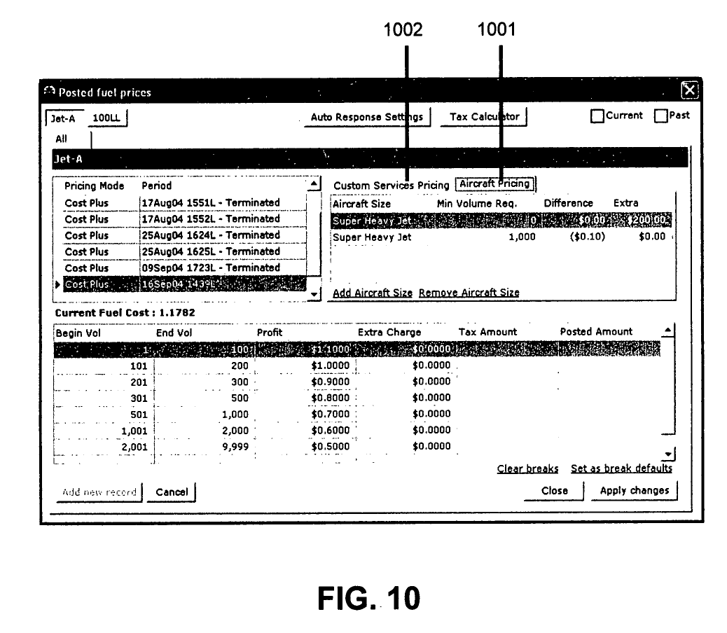

Price Display Screen (FIG. 10)

FIG. 10 depicts a typical price display screen, in this case, the FBO's posted price for jet fuel. This interactive screen further permits the FBO to specify volume discounts for fuel, and to specify extra charges and taxes. Costs for ground services may also be included with the price for the purposes of binding the two.

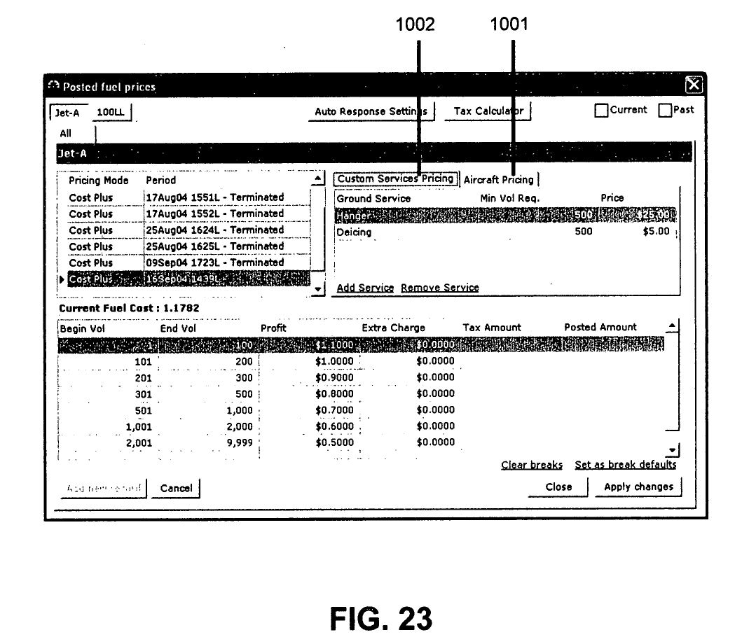

By clicking on the “Aircraft Pricing” tab 1001, the user is presented with the display depicted in FIG. 23, which further details the pricing, so as to be tied to a particular aircraft category (size). By clicking on the “Custom Services Pricing” tab 1002 in the screen depicted in FIG. 23, the user is returned to the screen depicted in FIG. 10.

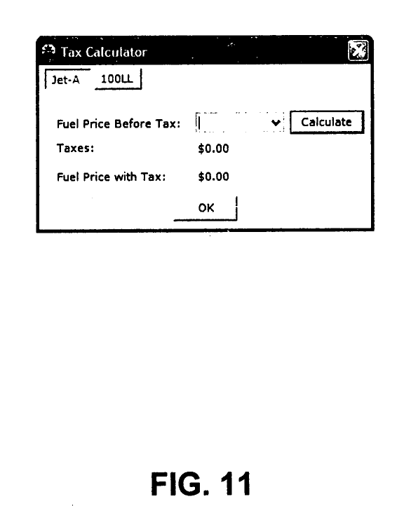

Tax Calculator (FIG. 11)

The screen shown in FIG. 11 allows the user to input a desired price for fuel and then calculate what the actual price would be with taxes added.

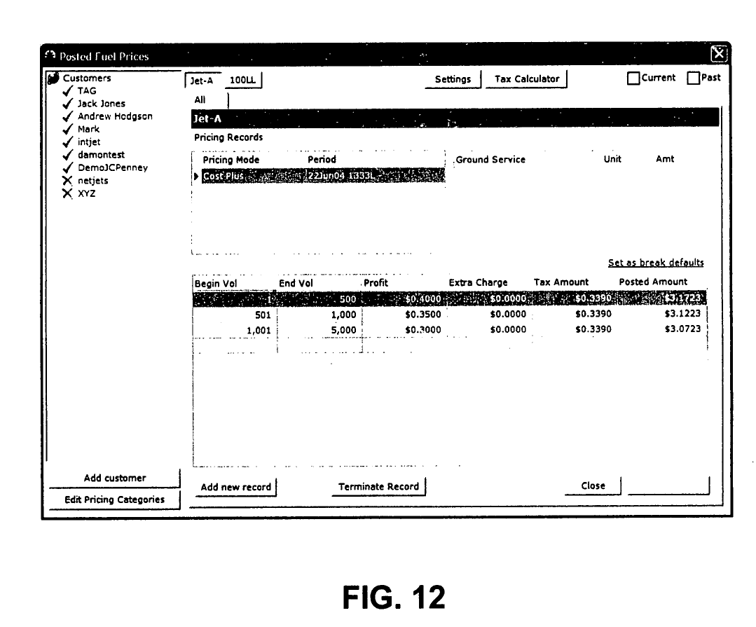

Private Pricing Display (FIG. 12)

FIG. 12 depicts a screen similar to that of FIG. 10, with the additional functionality of allowing an FBO to input and display price arrangements with specific customers. This allows FBOs to offer selective discounts to favored customers, for example.

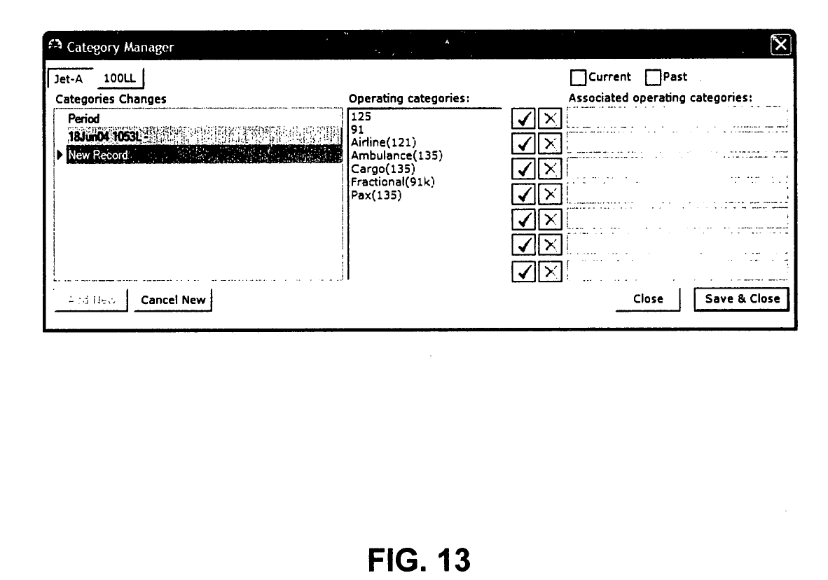

Price Category Manager (FIG. 13)

FIG. 13 depicts a screen which allows the FBO to create pricing categories by FAA operating rules. For example, Part 135 commercial operations may be priced differently than Part 191 not-for-hire operations.

Description of Operation

In operation, platform 10 offers many advantages to both the FBO and the ACOP, as well as maintenance providers 107, aircraft security providers 108, airport security providers 109, as well as the governmental agencies associated with general aviation. It is believed that these benefits may be more fully appreciated with reference to a description of operation of platform 10 in a specific situation.

Consider a scenario in which an aircraft operator desires to plan a trip involving a particular plane carrying specified passengers between City A and City C with a stopover in City B. The trip will involve catering, hotel accommodations, and ground transportation for the passengers and crew, use of a conference room at an FBO in City B. This particular aircraft operator is moderately price inelastic, desiring high quality services and facilities.

Those of ordinary skill in the art will appreciate that in this scenario, the aircraft operator has the option of using commercially-available aircraft scheduling software, or rely upon the ACOP gateway in accordance with the presently disclosed embodiment to accomplish the necessary scheduling tasks through the integration of required service tasks into an FBO's stream of work, thereby eliminating the need for many of the time-consuming, inefficient tasks (e.g., phone calls, fax communications, etc . . . ) required in the prior art.

First, in this exemplary scenario, the aircraft operator specifies desired parameters of the flight to be scheduled; these parameters include such details as the type of aircraft desired, the desired FBOs to be engaged, the departure and destination city pairs, the number of passengers, and so on. To this end, the aircraft operator begins by accessing the platform 10 via its ACOP gateway 102, and having done so, is presented with a display on terminal 302 which appears substantially as shown in FIG. 25. From this screen, the user (ACOP) selects a specific aircraft having a specific tail number, and then enters the city pairs (A-B-C). The ACOP also enters estimated departure dates and times, if known.

To the extent that the user has not previously specified to the platform 10 preferred FBOs in each city in the itinerary, the ACOP system will present the user with options in each city and prompt the user to make appropriate selections. This presentation of options is made on a screen which appears substantially as shown in FIG. 28. It is apparent from FIG. 28 that much information about each FBO is presented to the user, such as user ratings of facility and service, pricing arrangements, detailed amenities, and so, allowing the user to select the FBO that best suits his passengers or business model.

After the user has specified specific FBOs, he has the option of clicking on a link to create a communications thread enabling the user to communicate with the FBO, via the communications system and the application server 118, for example, to submit service requests, negotiate price, make inquiries. Each selection of a specific FBO creates a flight strip 1401 (see FIG. 14) within the specified FBO's EFIS FBO portal 101. The creation of each strip 1401 binds that specific aircraft's stop to that flight strip.

Frequently, aircraft schedulers must accomplish multiple tasks for multiple aircraft trips and stops. The system in accordance with the presently disclosed embodiment of the invention allows the aircraft scheduler to quickly move between tasks. Those of ordinary skill in the art will appreciate that the graphical format of data presented as shown in FIGS. 25, 28, and 29 enables the aircraft scheduler to be highly efficient in accomplishing the necessary tasks and establish the necessary communications threads required to accomplish those tasks.

Prior to departure, a crew member will file a flight plan either through the ACOP gateway 102 or through an FAA facility. At the destination FBO, the arrival field 1404 in the flight strip corresponding to this particular flight will provide an indication that the crew has filed a flight plan to that FBO's airport. This indication is updated as the flight departs, is en route, and nears arrival at the destination airport. Those of ordinary skill in the art will recognize that in accordance with one aspect of the invention, the flight status of the aircraft, from the filing of the flight plan through to arrival at the destination airport, depends upon the existence of the communications link (secure private network) between the application server cluster 118 and the aviation control centers (e.g., FAA 115, EuroControl 117, etc . . . ) as shown in FIG. 1.

Having monitored the progress of the flight and knowing that arrival is imminent (see reference numeral 3001), FBO personnel have positioned the limousine and/or rental cars near the planned parking location of the soon-to-arrive aircraft. Armed with pictures of the crew and/or passengers, FBO personnel are able to extend a very personal greeting based upon the information stored in the NOTES panel 1411 and any requests communicated to the FBO by the ACOP.

After the passengers have departed, a crew member will check in with the FBO. At this time, FBO personnel will access the flight's flight strip 1401 (see FIG. 14) and make appropriate notations as to the aircraft's arrival. The pilot might also issue appropriate service requests to the FBO, such as quantity of fuel requested and specific aircraft “pull-out” time. The FBO personnel then enters these requests into the appropriate service queues (see FIG. 17), including any date/time limiters.

The next day (or whenever the leg of the trip from City B to City C is scheduled), the line service field 1409 in the aircraft's flight strip 1401 will provide an indication that it is time to position the aircraft for passenger emplaning. In one embodiment, a warning indication occurs if the task not been accomplished within a certain period of time.

As fuel and ancillary services (e.g., catering) are provided, the PMTS (payments) field 1410 on the flight strip 1401 will indicate that billable items exist for eventual transfer to an invoice. Once an invoice is generated, the same field 1410 will provide an indication that payment is due, or that payment has been completed.

With regard to payment, the ACOP will have entered various forms of payment, e.g., American Express, MasterCard, open account, etc . . . The ACOP user will provide the ACOP gateway 102 with a preference as to the order in which the various forms of payment are presented to vendors. Likewise, vendors provide their portals with ordered preferences among various available methods of payment assuming that the ACOP has not indicated a preference. When the time comes for a payment to be made, platform 10 provides a payment solution by most preferred matches between ACOP's preferences and the vendors' preferences. Should the ACOP's selected form of payment be declined, platform 10 automatically and seamlessly reverts to the next most preferred payment method.

Regardless of the form(s) of payment used, platform 10 instantaneously provides the ACOP with detailed payment information that can be downloaded directly to the ACOP's accounting system and report-sorted by various categories, such as trip, leg, tail number, passenger, crew member, and so on. In accordance with another advantageous aspect of the presently disclosed embodiment of the invention, it should also be noted that a crew member by “signing” or entering a code on FBO verification device 208, will cause platform 10 to generate electronic proofs of services provided, thus eliminating the need to return paperwork to the ACOP.

As crew members and passengers arrive at the FBO, they will be identified by either with government identification (such as a driver's license) or be scanned biometrically. This information can be compared to encrypted identification/biometric data files attached to the crew and passenger manifest for this flight. Device 204 (see FIG. 2) will indicate whether each crew member and passenger is listed on the flight manifest and authorized to access the airport ramp and to board the aircraft. Device 204 will also indicate if any crew member or passenger poses an increased level of risk, based on information provided to platform 10 by appropriate security agencies, such as the U.S. Transportation Security Administration or private background checks. An indication of increased risk can trigger increased scrutiny on the part of FBO personnel.

As the crew and passengers are checking in, the ACOP is able to monitor progress to ensure, for example, that all crew and passengers are accounted for, that various services were provided as requested, and so on, by observing various indications appearing on the ACOP's flight strip 3001 and status display 3002 displayed on the ACOP's terminal 302 (see FIG. 3).

Once the crew and passengers have cleared security, platform 10 transmits to appropriate security agencies and flight control facilities, e.g., NORAD 120, TSA 121, and FAA 115 (see FIG. 1), a quantification of the potential risk posed by the aircraft based on a risk scoring algorithm which takes into account such factors as the potential lethality of the aircraft (due to its size and the amount of fuel carried), the reputation of the ACOP, a risk assessment of the individual passengers, and compliance with the security procedures required of the FBO, as described above. This risk assessment is available for use by flight control authorities, for example, to select flight paths that avoid sensitive or high-risk locations when the risk assessment suggests that it would be prudent to do so.

The foregoing exemplary scenario of the operation of platform 10 presupposed that the aircraft operator was an ACOP. Operation of platform 10 is somewhat different in instances where the aircraft operator is not an ACOP, and therefore does not have access to an ACOP gateway. To address such cases, the FBO portal 101 captures information regarding inbound aircraft and compares that information with the FBO's ACOP flight strips 1401. Of course, no flight strip 1401 will be found for a non-ACOP originated flight. Platform 10 then compares the inbound flight information to a list of aircraft that are intended to be filtered out, for example, an aircraft based at a competing FBO or in a private hangar.

Platform 10 then creates flight strips 1401 for all remaining flights. These flight strips contain information such as the operator of the aircraft, a flight history of the specific aircraft, a summary of aircraft operations for that operator, and a suggested price including volume discounts for that aircraft should it visit the FBO.

From the foregoing detailed description of specific embodiments of the invention, it should be apparent that methods and apparatuses for facilitating information, security and transaction exchange in aviation have been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested in the present disclosure, may be made to the disclosed embodiments without departing from the spirit and scope of the invention as defined by the appended claims, which follow.

1. A system for facilitating information, security, and transaction exchange relative to an airplane flight, comprising:
an application server;
an aircraft operator (ACOP) module, executing on a first computer having a display, said first computer being coupled to said application server via a communication system, said ACOP module being responsive to user input to generate at least one service request specifying at least one parameter of said airplane flight, said at least one service request being communicated by said communication system to said application server;
a fixed-base operator (FBO) module, executing on a second computer having a display, said FBO module being responsive to said service request forwarded from said application server to create and display a flight strip comprising a record containing a plurality of fields each corresponding to a parameter of said airplane flight;
wherein said FBO module communicates said flight strip to said application server;
and wherein said ACOP module accesses said flight strip at said application server such that an aircraft operator can monitor dynamic parameters of said airplane flight.
